(19) United States
(12) Patent Application Publication
(10) Pub. No.: US 2025/0344280 A1
(43) Pub. Date: Nov. 6, 2025

(54) Managing Data Communication in an Inactive State With a Network

(71) Applicant: GOOGLE LLC, Mountain View, CA (US)

(72) Inventor: Chih-Hsiang Wu, Taoyuan City (TW)

(21) Appl. No.: 18/869,232

(22) PCT Filed: May 23, 2023
(86) PCT No.: PCT/US23/67378

§ 371 Date: Nov. 25, 2024

Related U.S. Application Data
(60) Provisional application No. 63/345,018, filed on May 23, 2022.
(60) Provisional application No. 63/345,024, filed on May 23, 2022.

(51) Int. Cl. H04W 76/27; H04W 72/23

(52) U.S. Cl. CPC H04W 76/27; H04W 72/23

(57) ABSTRACT

To perform channel monitoring, a user equipment monitors (1104) a physical downlink control channel (PDCCH) using a radio network temporary identifier (RNTI), during a small data transmission (SDT) procedure and when the UE operates in an inactive state (1102). The UE transitions from the inactive state to a connected state in response to a command from a radio access network (RAN) (1110); and monitors (1110) the downlink control channel using the RNTI after the transitioning, when the UE operates in the connected state.

### CROSS-REFERENCE TO RELATED APPLICATIONS

This application claims priority to and the benefit of the filing date of provisional U.S. Patent Application No. 63/345,018, titled “Managing Data Communication in an Inactive State with a Network,” filed on May 23, 2022 and provisional U.S. Patent Application No. 63/345,024, titled “Managing Data Communication with a User Equipment Operating in an Inactive State,” filed on May 23, 2022. The entire contents of the provisional applications are hereby expressly incorporated herein by reference.

### FIELD OF THE DISCLOSURE

This disclosure relates generally to wireless communications and, more particularly, to communication of uplink and/or downlink data at a user equipment (UE) and a base station when the UE operates in an inactive or idle state associated with a protocol for controlling radio resources.

### BACKGROUND

This background description is provided for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

Generally speaking, a base station operating in a cellular radio access network (RAN) communicates with a user equipment (UE) using a certain radio access technology (RAT) and multiple layers of a protocol stack. For example, the physical layer (PHY) of a RAT provides transport channels to the Medium Access Control (MAC) sublayer, which in turn provides logical channels to the Radio Link Control (RLC) sublayer, and the RLC sublayer in turn provides data transfer services to the Packet Data Convergence Protocol (PDCP) sublayer. The Radio Resource Control (RRC) sublayer is disposed above the PDCP sublayer.

The RRC sublayer specifies the RRC_IDLE state, in which a UE does not have an active radio connection with a base station; the RRC_CONNECTED state, in which the UE has an active radio connection with the base station; and the RRC_INACTIVE state to allow a UE to more quickly transition back to the RRC_CONNECTED state using RAN-level base station coordination and RAN-level paging procedures. In some cases, the UE in the RRC_INACTIVE state has only one, relatively small packet to transmit. For situations such as these, a Small Data Transmission (SDT) procedure is used to enable the node to support data transmission for the UE operating in the RRC_INACTIVE state (i.e., without requiring that the UE transition to the RRC_CONNECTED state).

The RAN enables SDT on a radio bearer basis, and the UE initiates SDT when less than a configured amount of uplink data awaits transmission across all radio bearers for which SDT is enabled, the downlink (DL) reference signal received power (RSRP) is above a configured threshold, and a valid SDT resource is available. The UE can initiate an SDT procedure with either a transmission over a random access channel (RACH) (i.e., random access SDT (RA-SDT)) or over Type 1 configured grant (CG) resources (i.e., CG-SDT). For RA-SDT, the network configures 2-step and/or 4-step random access resources for SDT. In the RA-SDT, the UE transmits an initial transmission including data in a message 3 (MSG3) of a 4-step random access procedure or in a payload of a message A (MSGA) of a 2-step random access procedure. The network can then schedule subsequent uplink and/or downlink transmissions using dynamic uplink grants and downlink assignments, respectively, after completion of the random access procedure.

Further, the UE can initiate CG-SDT only with valid uplink (UL) timing alignment. The UL timing alignment is maintained by the UE based on a network-configured, SDT-specific timing alignment timer and a DL RSRP of a configured number of highest ranked SSBs. Upon expiration of the SDT-specific timing alignment timer, the CG resources are released. Upon initiating the CG-SDT, the UE transmits an initial transmission including data on a CG occasion using a CG configuration, and the network can schedule subsequent uplink transmissions using dynamic grants or on future CG resource occasions. During the CG-SDT, the downlink transmissions are scheduled using dynamic assignments. The UE can initiate subsequent uplink transmission only after receiving, from the network, confirmation for the initial uplink transmission.

In some scenarios, the MAC entity is configured by RRC with SDT, and the SDT procedure is initiated by an RRC layer. In further scenarios, the SDT procedure is performed either by Random Access procedure with 2-step RA type or 4-step RA type (i.e., RA-SDT) or by configured grant Type 1 (i.e., CG-SDT), as discussed above.

The RRC layer configures the following parameters for SDT procedure: (i) sdt-Data VolumeThreshold-a data volume threshold for the UE to determine whether to perform SDT procedure; (ii) sdt-RSRP-Threshold—an RSRP threshold for UE to determine whether to perform SDT procedure; and (iii) cg-SDT-RSRP-ThresholdSSB—an RSRP threshold configured for SSB selection for CG-SDT.

The MAC entity, if initiated by the upper layers for SDT procedure performs the following: (i) if the data volume of the pending UL data across all RBs configured for SDT is less than or equal to sdt-Data VolumeThreshold; and (ii) if the RSRP of the downlink pathloss reference is higher than sdt-RSRP-Threshold: (a) if the Serving Cell for SDT is configured with supplementary uplink; and (b) if the RSRP of the downlink pathloss reference is less than rsrp-ThresholdSSB-SUL: the MAC entity selects the SUL carrier. Otherwise, the MAC entity selects the NUL carrier. If CG-SDT is configured on the selected UL carrier, and TA of the configured grant Type 1 resource is valid; and if at least one SSB configured for CG-SDT with SS-RSRP above cg-SDT-RSRP-ThresholdSSB is available: the MAC entity indicates to the upper layers that the conditions for initiating SDT procedure are fulfilled; and performs CG-SDT procedure on the selected UL carrier.

In some scenarios, for SDT procedures, the MAC entity also considers the suspended RBs configured with SDT for data volume calculation. It is up to the UE's implementation how the UE calculates the data volume for the suspended RBs. In further scenarios, the size of the CCCH message is not considered for data volume calculation. Otherwise, if a set of Random Access resources to indicate RA-SDT are available on the selected UL carrier: the MAC entity considers cg-SDT-TimeAlignmentTimer as expired and performs the corresponding actions (e.g., as specified in clause 5.2 of TS 38.321) and indicates to the upper layers that the conditions for initiating SDT procedure are fulfilled. Otherwise, the MAC entity indicates to the upper layers that the conditions for initiating SDT procedure are not fulfilled.

Otherwise, if (i) and (ii) are not met, the MAC entity indicates to the upper layers that the conditions for initiate SDT procedure are not fulfilled.

If RA-SDT is selected above and after the Random Access procedure is successfully completed, the UE monitors the physical downlink control channel (PDCCH) addressed to a cell radio network temporary identifier (C-RNTI) until the RA-SDT procedure is terminated. If CG-SDT is selected above and after the initial transmission for CG-SDT is performed, the UE monitors PDCCH addressed to C-RNTI and CS-RNTI until the CG-SDT procedure is terminated.

Accordingly, in some scenarios, the UE connects to a RAN (e.g., a 5G NR radio access network (NG-RAN)) that includes base stations, each having a central unit (CU) and at least one distributed unit (DU). However, it is not clear how a UE manages data communication with the NG-RAN while operating in the RRC_INACTIVE state and when transitioning to the RRC_CONNECTED state from the RRC_INACTIVE state. For example, it is not clear how the UE obtains a CS-RNTI for CG-SDT.

Further, the UE monitors PDCCH addressed to a C-RNTI until the SDT procedure (i.e., RA-SDT or CG-SDT) is terminated. In other words, the UE does not monitor PDCCH addressed to C-RNTI after terminating the SDT procedure. In some cases, the UE terminates the SDT procedure because the UE transitions to the RRC_CONNECTED state from the INACTIVE state. In such cases, it is not clear which C-RNTI should be used by the UE to monitor PDCCH after transitioning to the RRC_CONNECTED state from the RRC_INACTIVE state.

### SUMMARY

An example embodiment of the techniques of this disclosure is a channel monitoring method implemented in a UE. The method comprises monitoring a physical downlink control channel (PDCCH) using a radio network temporary identifier (RNTI), during a small data transmission (SDT) procedure and when the UE operates in an inactive state; transitioning from the inactive state to a connected state in response to a command from a radio access network (RAN); and monitoring the downlink control channel using the RNTI after the transitioning, when the UE operates in the connected state.

Another example embodiment of these techniques is a user equipment (UE) comprising a transceiver and processing hardware configured to implement the method above.

Another example embodiment of these techniques is a communication method implemented in a radio access network (RAN) node. The method comprises performing a small data transmission (SDT) procedure with a user equipment (UE), when the UE operates in an inactive state, using a radio network temporary identifier (RNTI); transmitting, to the UE, a command to transition from the inactive state to a connected state; and communicating with the UE using the RNTI, when the UE operates in the connected state.

Another example embodiment of these techniques is a radio access network (RAN) node comprising a transceiver and processing hardware configured to implement the method above.

### BRIEF DESCRIPTION OF THE DRAWINGS

FIG. 1A is a block diagram of an example wireless communication system in which a user device and a base station of this disclosure can implement the techniques of this disclosure for reducing latency in data communication;

FIG. 1B is a block diagram of an example base station in which a centralized unit (CU) and a distributed unit (DU) that can operate in the system of FIG. 1A;

FIG. 2A is a block diagram of an example protocol stack according to which the UE of FIG. 1A communicates with base stations;

FIG. 2B is a block diagram of an example protocol stack according to which the UE of FIG. 1A communicates with a CU and a DU;

FIG. 3 is a messaging diagram of an example procedure for obtaining a non-SDT configuration for obtaining an SDT configuration for communicating data packets between the UE and the distributed base station when the radio connection between the UE and the base station is inactive;

FIG. 4 is a messaging diagram of an example procedure for communicating data packets between a UE and a distributed base station when a radio connection between the UE and the base station is inactive;

FIG. 5A is a messaging diagram of an example procedure for communicating data packets between a UE and a distributed base station when a radio connection between the UE and the base station is inactive and later is active;

FIG. 5B is a messaging diagram of an example procedure for communicating data packets between a UE and a distributed base station when a radio connection between the UE and the base station is inactive and later is active; and

FIG. 6A is a flow diagram of an example method, implemented in the UE of FIG. 1A, for receiving a CS-RNTI, SDT configuration parameters, and non-SDT configuration parameters from a RAN;

FIG. 6B is a flow diagram of an example method similar to FIG. 6A, but in which the UE receives the CS-RNTI and the SDT configuration parameters in a release message;

FIG. 7 is a flow diagram of an example method, implemented in the UE of FIG. 1A, for performing SDT using a CS-RNTI received in an RRC release message or an RRC reconfiguration message;

FIG. 8 is a flow diagram of an example method, implemented in the UE of FIG. 1A, for determining whether to retain or release a CS-RNTI based on whether a release message configures CG-SDT;

FIG. 9 is a flow diagram of an example method, implemented in the UE of FIG. 1A, for determining whether to use a CS-RNTI to monitor a PDCCH based on whether a message includes a configured grant configuration;

FIG. 10A is a flow diagram of an example method, implemented in the UE of FIG. 1A, for monitoring a PDCCH using a C-RNTI before and after transitioning to a connected state;

FIG. 10B is a flow diagram of an example method similar to FIG. 10A, but in which the UE transitions to the connected state in response to receiving a setup message rather than a resume message;

FIG. 11 is a flow diagram of an example method, implemented in the UE of FIG. 1A, for determining whether to continue using a C-RNTI to monitor a PDCCH based on whether a message causes the UE to transition to a connected state;

FIG. 12A is a flow diagram of an example method, implemented in the RAN of FIG. 1A, for transmitting SDT configuration parameters, non-SDT configuration parameters, and a CS-RNTI for performing data communication with a UE in an inactive state;

FIG. 12B is a flow diagram of an example method similar to FIG. 12A, but in which the RAN receives a capability indicating support for a CS-RNTI and transmits the SDT configuration parameters and the CS-RNTI in a release message;

FIG. 12C is a flow diagram of an example method similar to FIG. 12A, but in which the RAN determines whether to transmit the SDT configuration parameters and the CS-RNTI in a release message based on whether the UE supports receiving the CS-RNTI;

FIG. 13 is a flow diagram of an example method, implemented in the RAN of FIG. 1A, for determining whether to transmit a message configuring or releasing CG-SDT based on whether the RAN configures CG-SDT for a UE;

FIG. 14 is a flow diagram of an example method, implemented in the DU of FIG. 1B, for determining whether to retain or release a CS-RNTI and CG configuration based on whether the CS-RNTI and CG configuration are configured for CG-SDT;

FIG. 15A is a flow diagram of an example method, implemented in the RAN of FIG. 1A, for using a C-RNTI to perform data communication with a UE before and after stopping SDT via a resume message to the UE;

FIG. 15B is a flow diagram of an example method similar to FIG. 15A, but in which the RAN stops SDT by transmitting a setup message to the UE; and

FIG. 16 is a flow diagram of an example method, implemented in the RAN of FIG. 1A, for determining whether to continue or stop using a C-RNTI to perform data communication with a UE based on whether a message to the UE causes the UE to transition to a connected state.

### DETAILED DESCRIPTION OF THE DRAWINGS

As discussed in more detail below, a user equipment (UE) and/or a network node of a radio access network (RAN) can use the techniques of this disclosure for managing small data communication and transitioning a UE between states of a protocol for controlling radio resources between the UE and the RAN. As used in this disclosure, small data communication can refer to small data transmission (SDT) from the perspective of the network (i.e., SDT in the downlink direction), or SDT from the perspective of the UE (i.e., SDT in the uplink direction).

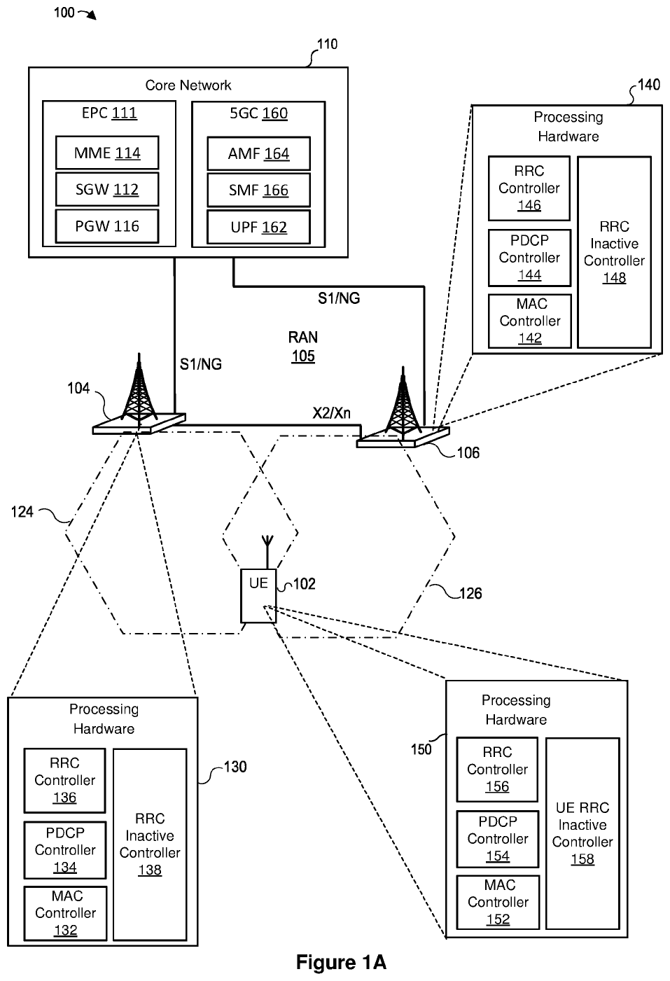

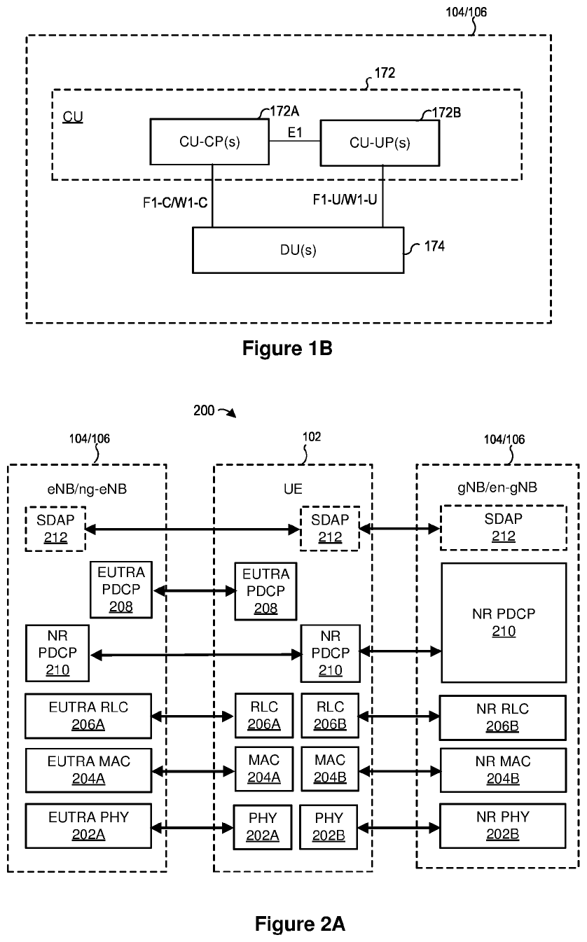

Referring first to FIG. 1A, an example wireless communication system 100 includes a UE 102, a base station (BS) 104, a base station 106, and a core network (CN) 110. The base stations 104 and 106 can operate in a RAN 105 connected to the core network (CN) 110. The CN 110 can be implemented as an evolved packet core (EPC) 111 or a fifth generation (5G) core (5GC) 160, for example. The CN 110 can also be implemented as a sixth generation (6G) core in another example.

The base station 104 covers a cell 124, and the base station 106 covers a cell 126. If the base station 104 is a gNB, the cell 124 is an NR cell. If the base station 104 is an ng-eNB, the cell 124 is an evolved universal terrestrial radio access (E-UTRA) cell. Similarly, if the base station 106 is a gNB, the cell 126 is an NR cell, and if the base station 106 is an ng-eNB, the cell 126 is an E-UTRA cell. The cells 124 and 126 can be in the same Radio Access Network Notification Areas (RNA) or different RNAs. In general, the RAN 105 can include any number of base stations, and each of the base stations can cover one, two, three, or any other suitable number of cells. The UE 102 can support at least a 5G NR (or simply, “NR”) or E-UTRA air interface to communicate with the base stations 104 and 106. Each of the base stations 104, 106 can connect to the CN 110 via an interface (e.g., S1 or NG interface). The base stations 104 and 106 also can be interconnected via an interface (e.g., X2 or Xn interface) for interconnecting NG RAN nodes.

Among other components, the EPC 111 can include a Serving Gateway (SGW) 112, a Mobility Management Entity (MME) 114, and a Packet Data Network Gateway (PGW) 116. The SGW 112 in general is configured to transfer user-plane packets related to audio calls, video calls, Internet traffic, etc., and the MME 114 is configured to manage authentication, registration, paging, and other related functions. The PGW 116 provides connectivity from the UE to one or more external packet data networks, e.g., an Internet network and/or an Internet Protocol (IP) Multimedia Subsystem (IMS) network. The 5GC 160 includes a User Plane Function (UPF) 162 and an Access and Mobility Management Function (AMF) 164, and/or Session Management Function (SMF) 166. Generally speaking, the UPF 162 is configured to transfer user-plane packets related to audio calls, video calls, Internet traffic, etc., the AMF 164 is configured to manage authentication, registration, paging, and other related functions, and the SMF 166 is configured to manage PDU sessions.

As illustrated in FIG. 1A, the base station 104 supports a cell 124, and the base station 106 supports a cell 126. The cells 124 and 126 can partially overlap, so that the UE 102 can select, reselect, or hand over from one of the cells 124 and 126 to the other. To directly exchange messages or information, the base station 104 and base station 106 can support an X2 or Xn interface. In general, the CN 110 can connect to any suitable number of base stations supporting NR cells and/or EUTRA cells.

The CN 110 may also communicatively connect the UE 102 to an Internet Protocol (IP) Multimedia Subsystem (IMS) network 170, via the RAN 105. The IMS network 170 can provide to the UE 102 various IMS services, such as IMS short messages, IMS unstructured supplementary service data (USSD), IMS value added service data, IMS supplementary service data, IMS voice calls, and IMS video calls. To this end, an entity (e.g., a server or a group of servers) operating in the IMS network 170 supports packet exchange with the UE. The packets can convey signaling (such as session initiation protocol (SIP) messages, IP messages, or other suitable messages) as well as data (“or media”) such as voice or video.

As discussed in detail below, the UE 102 and/or the RAN 105 may utilize the techniques of this disclosure when the radio connection between the UE 102 and the RAN 105 is suspended, e.g., when the UE 102 operates in an inactive or idle state of the protocol for controlling radio resources between the UE 102 and the RAN 105. For clarity, the examples below refer to the RRC_INACTIVE or RRC_IDLE state of the RRC protocol. As discussed below, the UE 102 in some implementations applies the techniques of this disclosure only if the size of the data (e.g., UL data) is below a certain threshold value.

In the example scenarios discussed below, the UE 102 transitions to the RRC_INACTIVE or RRC_IDLE state, selects a cell of the base station 104, and exchanges data with the base station 104, either via the base station 106 or with the base station 104 directly, without transitioning to RRC_CONNECTED state. As a more specific example, after the UE 102 determines that data is available for uplink transmission in the RRC_INACTIVE or RRC_IDLE state, the UE 102 can apply one or more security functions to an uplink (UL) data packet, generate a first UL protocol data unit (PDU) including the security-protected packet, include a UL RRC message along with the first UL PDU in a second UL PDU, and transmit the second UL PDU to the RAN 105. The UE 102 includes a UE identity/identifier (ID) for the UE 102 in the UL RRC message. The RAN 105 can identify the UE 102 based on the UE ID. In some implementations, the UE ID can be an inactiPDve Radio Network Temporary Identifier (I-RNTI), a resume ID, or a non-access stratum (NAS) ID. The NAS ID can be an S-Temporary Mobile Subscriber Identity (S-TMSI) or a Global Unique Temporary Identifier (GUTI).

The security function can include an integrity protection and/or encryption function. When integrity protection is enabled, the UE 102 can generate a message authentication code for integrity (MAC-I) to protect integrity of the data. Thus, the UE 102 in this case generates a security-protected packet including the data and the MAC-I. When encryption is enabled, the UE 102 can encrypt the data to obtain an encrypted packet, so that the security-protected packet includes encrypted data. When both integrity protection and encryption are enabled, the UE 102 can generate a MAC-I for protecting integrity of the data and encrypt the data along with the MAC-I to generate an encrypted packet and an encrypted MAC-I. The UE 102 then can transmit the security-protected packet to the RAN 105 while in the RRC_INACTIVE or RRC_IDLE state.

In some implementations, the data is a UL service data unit (SDU) of the packet data convergence protocol (PDCP) or SDAP. The UE 102 applies the security function to the SDU and includes the secured SDU in a first UL PDU (e.g., a UL PDCP PDU). The UE 102 then includes the UL PDCP PDU in a second UL PDU such as a UL MAC PDU, which can be associated with the medium access control (MAC) layer. Thus, the UE 102 in these cases transmits the secured UL PDCP PDU in the UL MAC PDU. In some implementations, the UE 102 can include, in the UL MAC PDU, a UL RRC message. In other implementations, the UE 102 may omit a UL RRC message from the UL MAC PDU. In this latter case, the UE 102 may omit a UE ID of the UE 102 from the UL MAC PDU that does not include a UL RRC message. In yet further implementations, the UE 102 can include the UL PDCP PDU in a UL radio link control (RLC) PDU and then include the UL RLC PDU in the UL MAC PDU. In some implementation in which the UL RRC message is included in the UL MAC PDU, the UE 102 generates an RRC MAC-I and includes the RRC MAC-I in the UL RRC message. For example, the RRC MAC-I may be a resumeMAC−1 field, as specified in 3GPP specification 38.331. In further implementations, the UE can obtain the RRC MAC-I from the UL RRC message with an integrity kcy (e.g., KRRCint key), an integrity protection algorithm, and the parameters COUNT (e.g., 32-bit, 64-bit or 128-bit value), BEARER (e.g., 5-bit value) and DIRECTION (e.g., 1-bit value).

In further implementations, the data is a UL SDU of the NAS. The UE 102 applies the security function to the SDU and includes the secured SDU in a first UL PDU such as a NAS PDU, which can be associated with the NAS layer. For example, the NAS layer can be an MM sublayer or SM sublayer of 5G, Evolved Packet System (EPS), or 6G. The UE 102 can then include the UL NAS PDU in a second UL PDU such as a UL RRC message. Thus, the UE 102 in these cases transmits the (first) secured UL NAS PDU in the UL RRC message. In some implementations, the UE 102 can include the UL RRC message in a UL MAC PDU and transmits the UL MAC PDU to a base station (e.g., base station 104 or 106) via a cell (e.g., cell 124 or 126). In this case, the UE 102 may not include an RRC MAC-I in the UL RRC message. Alternatively, the UE 102 may include an RRC MAC-I as described above.

In some implementations, the UL RRC message described above can be a common control channel (CCCH) message, an RRC resume request message, or an RRC early data request message. The UL RRC message can include a UE ID of the UE 102 as described above.

More generally, the UE 102 can secure the data using at least one of encryption and integrity protection, include the secured data as a security-protected packet in the first UL PDU, and transmit the first UL PDU to the RAN 105 in the second UL PDU.

In some scenarios and implementations, the base station 106 can retrieve the UE ID of the UE 102 from the UL RRC message and identify the base station 104 as the destination of the data in the first UL PDU, based on the determined UE ID. In such scenarios, the base station 106 can be referred as the “anchor” base station that sent the UE 102 into the inactive state while retaining the full UE context information. In one example implementation, the base station 106 retrieves the first UL PDU from the second UL PDU and transmits the first UL PDU to the base station 104. The base station 104 then retrieves the security-protected packet from the first UL PDU, applies one or two security functions to decrypt the data and/or check the integrity protection, and transmits the data to the CN 110 (e.g., SGW 112, UPF 162, MME 114 or AMF 164) or an edge server. In some implementations, the edge server can operate within the RAN 105. More specifically, the base station 104 derives at least one security key from UE context information of the UE 102. Then the base station 104 retrieves the data from the security-protected packet by using the at least one security key and transmits the data to the CN 110 or edge server. When the security-protected packet is an encrypted packet, the base station 104 decrypts the encrypted packet to obtain the data by using the at least one security key (e.g., an encryption and/or decryption key). If the security-protected packet is an integrity-protected packet, the integrity-protected packet may include the data and the MAC-I. The base station 104 can verify whether the MAC-I is valid for the security-protected packet by using the at least one security key (e.g., an integrity key). When the base station 104 confirms that the MAC-I is valid, the base station 104 sends the data to the CN 110 or edge server. However, when the base station 104 determines that the MAC-I is invalid, the base station 104 discards the security-protected packet. Further, if the security-protected packet is both encrypted and integrity-protected, the encrypted and integrity-protected packet may include the encrypted packet along with the encrypted MAC-I. The base station 104 in this case decrypts the encrypted packet and the encrypted MAC-I to obtain the data and the MAC-I. The base station 104 then determines whether the MAC-I is valid for the data. If the base station 104 determines that the MAC-Iis valid, the base station 104 retrieves the data and forwards the data to the CN 110 or edge server. However, if the base station 104 determines that the MAC-I is invalid, the base station 104 discards the packet.

In another implementation, the base station 106 retrieves the security-protected packet from the first UI, PDU. The base station 106 performs a retrieve UF context procedure with the base station 104 to obtain UE context information of the UE 102 from the base station 104. The base station 106 derives at least one security key from the UE context information. Then the base station 106 retrieves the data from the security-protected packet by using the at least one security key and transmits the data to the CN 110 (e.g., UPF 162) or an edge server. When the security-protected packet is an encrypted packet, the base station 106 decrypts the encrypted packet to obtain the data by using the at least one security key (e.g., an encryption and/or decryption key). If the security-protected packet is an integrity-protected packet, the integrity protected packet may include the data and the MAC-I. The base station 106 can verify whether the MAC-I is valid for the security-protected packet by using the at least one security key (e.g., an integrity key). When the base station 106 confirms that the MAC-I is valid, the base station 106 sends the data to the CN 110. On the other hand, when the base station 106 determines that the MAC-I is invalid, the base station 106 discards the security-protected packet. Further, if the security-protected packet is both encrypted and integrity-protected, the encrypted and integrity-protected packet may include the encrypted packet along with the encrypted MAC-I. The base station 106 in this case decrypts the encrypted packet and the encrypted MAC-I to obtain the data and the MAC-I. The base station 106 then determines whether the MAC-I is valid for the data. If the base station 106 determines that the MAC-I is valid, the base station 106 retrieves the data and forwards the data to the CN 110. However, if the base station 106 determines that the MAC-I is invalid, the base station 106 discards the packet.

In other scenarios and implementations, the base station 104 can retrieve the UE ID of the UE 102 from the UL RRC message and identify that the base station 104 stores UE context information of the UE 102. Thus, the base station 104 retrieves the security-protected packet from the first UL PDU, retrieves the data from the security-protected packet, and sends the data to the CN 110 or edge server as described above.

Further, the RAN 105 in some cases transmits data in the downlink (DL) direction to the UE 102 operating in the RRC_INACTIVE or RRC_IDLE state.

For example, when the base station 104 determines that data is available for downlink transmission to the UE 102 currently operating in the RRC_INACTIVE or RRC_IDLE state, the base station 104 can apply at least one security function to the data to generate a security-protected packet, generate a first DI. PDU including the security-protected packet, and the first DL PDU in a second DL PDU. To secure the data, the base station 104 can apply the security function (e.g., integrity protection and/or encryption) to the data. More particularly, when integrity protection is enabled, the base station 104 generates a MAC-I for protecting integrity of the data, so that the security-protected packet includes the data and the MAC-I. When encryption is enabled, the base station 104 encrypts the data to generate an encrypted packet, so that the security-protected packet is an encrypted packet. Further, when both integrity protection and encryption are enabled, the base station 104 can generate a MAC-I for protecting the integrity of the data and encrypt the data along with the MAC-I to generate an encrypted packet and an encrypted MAC-I. The base station 104 in some implementations generates a first DL PDU, such as a DL PDCP PDU, using the security-protected packet, includes the first DL PDU in a second DL PDU associated with the MAC layer for example (e.g., a DL MAC PDU), and transmits the second DL PDU to the UE 102 without first causing the UE 102 to transition from the RRC_INACTIVE or RRC_IDLE state to the RRC_CONNECTED state. In some implementations, the base station 104 includes the DL PDCP PDU in a DL RLC PDU, includes the DL RLC PDU in the DL MAC PDU and transmits the DL MAC PDU to the UE 102 without first causing the UE 102 to transition from the RRC_INACTIVE or RRC_IDLE state to the RRC_CONNECTED state.

In another implementation, the base station 104 transmits the first DL PDU to the base station 106, which then generates a second PDU (e.g., a DL MAC PDU) including the first DL PDU and transmits the second DI PDU to the UF 102 without first causing the UE 102 to transition from the RRC_INACTIVE or RRC_IDLE state to the RRC_CONNECTED state. In some implementations, the base station 106 generates a DL RLC PDU including the first DL PDU and includes the DL RLC PDU in the second DL PDU. In yet another implementation, the base station 104 includes the first DL PDU in a DL RLC PDU and transmits the DL RLC PDU to the base station 106, which then generates a second DL PDU (e.g., a DL MAC PDU), including the DL RLC PDU, and transmits the second DL PDU to the UE 102.

In some implementations, the base station (i.e., the base station 104 or 106) generates a downlink control information (DCI) and a cyclic redundancy check (CRC) scrambled with an ID of the UE 102 to transmit the second DL PDU generated by the base station. In some implementations, the ID of the UE 102 can be a Radio Network Temporary Identifier (RNTI). For example, the RNTI can be a cell RNTI (C-RNTI), a temporary C-RNTI or an inactive C-RNTI. The base station transmits the DCI and scrambled CRC on a physical downlink control channel (PDCCH) to the UE 102 operating in the RRC_INACTIVE or RRC_IDLE state. The base station scrambles the CRC with the ID of the UE 102. In some implementations, the base station may assign the ID of the UE 102 to the UE 102 in a random access response that the base station transmits in a random access procedure with the UE 102 before transmitting the DCI and scrambled CRC. In further implementations, the base station may assign the ID of the UE 102 to the UE 102 in an RRC message (e.g., RRC release message or an RRC reconfiguration message) that the base station transmits to the UE 102 before transmitting the DCI and scrambled CRC, e.g., while the UE 102 was in the RRC_CONNECTED state.

The UE 102 operating in the RRC_INACTIVE or RRC_IDLE state can receive the DCI and scrambled CRC on the PDCCH. The UE 102 then confirms that a physical downlink shared channel (PDSCH), including the second DL PDU, is addressed to the UE 102 according to the ID of the UE 102, DCI, and scrambled CRC. The UE 102 then can retrieve the data from the security-protected packet. If the security-protected packet is an encrypted packet, the UE 102 can decrypt the encrypted packet using the appropriate decryption function and the security key to obtain the data. If the security-protected packet is the integrity-protected packet including the data and the MAC-I, the UE 102 can determine whether the MAC-I is valid. If the UE 102 confirms that the MAC-I is valid, the UF 102 retrieves the data. If, however, the UF 102 determines that the MAC-I is invalid, the UE 102 discards the packet. Finally, when the security-protected packet is both encrypted and integrity-protected, with encrypted data and an encrypted MAC-I, the UE 102 can decrypt the encrypted packet and encrypted MAC-I to obtain the data and the MAC-I. The UE 102 can then verify that the MAC-I is valid for the data. If the UE 102 confirms that the MAC-I is valid, the UE 102 retrieves and processes the data. Otherwise, when the UE 102 determines that the MAC-I is invalid, the UE 102 discards the data.

The base station 104 is equipped with processing hardware 130 that can include one or more general-purpose processors (e.g., CPUs) and a non-transitory computer-readable memory storing instructions that the one or more general-purpose processors execute. Additionally or alternatively, the processing hardware 130 can include special-purpose processing units. The processing hardware 130 in an example implementation includes a Medium Access Control (MAC) controller 132 configured to perform a random access procedure with one or more user devices, receive uplink MAC protocol data units (PDUs) to one or more user devices, and transmit downlink MAC PDUs to one or more user devices. The processing hardware 130 can also include a Packet Data Convergence Protocol (PDCP) controller 134 configured to transmit DL PDCP PDUs in accordance with which the base station 104 can transmit data in the downlink direction in some scenarios, and receive UL PDCP PDUs in accordance with which the base station 104 can receive data in the uplink direction in other scenarios. The processing hardware further can include an RRC controller 136 to implement procedures and messaging at the RRC sublayer of the protocol communication stack. The processing hardware 130 in an example implementation includes an RRC inactive controller 138 configured to manage uplink and/or downlink communications with one or more UEs operating in the RRC_INACTIVE or RRC_IDLE state. The base station 106 can include generally similar components. In particular, components 140, 142, 144, 146, and 148 of the base station 106 can be similar to the components 130, 132, 134, 136, and 138, respectively.

The UE 102 is equipped with processing hardware 150 that can include one or more general-purpose processors such as CPUs and non-transitory computer-readable memory storing machine-readable instructions executable on the one or more general-purpose processors, and/or special-purpose processing units. The processing hardware 150 in an example implementation includes an RRC inactive controller 158 configured to manage uplink and/or downlink communications when the UE 102 operates in the RRC_INACTIVE state. The processing hardware 150 in an example implementation includes a Medium Access Control (MAC) controller 152 configured to perform a random access procedure with a base station, transmit uplink MAC protocol data units (PDUs) to the base station, and receive downlink MAC PDUs from the base station. The processing hardware 150 can also include a PDCP controller 154 configured to transmit DL PDCP PDUs in accordance with which the base station 106 can transmit data in the downlink direction in some scenarios, and receive UL PDCP PDUs in accordance with which the base station 106 can receive data in the uplink direction in other scenarios. The processing hardware further can include an RRC controller 156 to implement procedures and messaging at the RRC sublayer of the protocol communication stack.

FIG. 1B depicts an example distributed or disaggregated implementation of any one or more of the base stations 104, 106. In this implementation, the base station 104, 106 includes a central unit (CU) 172 and one or more distributed units (DUs) 174. The CU 172 includes processing hardware, such as one or more general-purpose processors (e.g., CPUs) and a computer-readable memory storing machine-readable instructions executable on the general-purpose processor(s), and/or special-purpose processing units. For example, the CU 172 can include a PDCP controller, an RRC controller and/or an RRC inactive controller such as PDCP controller 134, 144, RRC controller 136, 146 and/or RRC inactive controller 138, 148. In some implementations, the CU 172 can include a radio link control (RLC) controller configured to manage or control one or more RLC operations or procedures. In further implementations, the CU 172 does not include an RLC controller.

Each of the DUs 174 also includes processing hardware that can include one or more general-purpose processors (e.g., CPUs) and computer-readable memory storing machine-readable instructions executable on the one or more general-purpose processors, and/or special-purpose processing units. For example, the processing hardware can include a MAC controller (e.g., MAC controller 132, 142) configured to manage or control one or more MAC operations or procedures (e.g., a random access procedure), and/or an RLC controller configured to manage or control one or more RLC operations or procedures. The process hardware can also include a physical layer controller configured to manage or control one or more physical layer operations or procedures.

In some embodiments, the RAN 105 supports Integrated Access and Backhaul (IAB) functionality. In some implementations, the DU 174 operates as an (IAB)-node, and the CU 172 operates as an IAB-donor.

In some implementations, the CU 172 can include a logical node CU-CP 172A that hosts the control plane part of the PDCP protocol of the CU 172. The CU 172 can also include logical node(s) CU-UP 172B that hosts the user plane part of the PDCP protocol and/or Service Data Adaptation Protocol (SDAP) protocol of the CU 172. The CU-CP 172A can transmit control information (e.g., RRC messages, F1 application protocol messages), and the CU-UP 172B can transmit the data packets (e.g., SDAP PDUs or Internet Protocol packets).

The CU-CP 172A can be connected to multiple CU-UP 172B through the E1 interface. The CU-CP 172A selects the appropriate CU-UP 172B for the requested services for the UE 102. In some implementations, a single CU-UP 172B can connect to multiple CU-CP 172A through the E1 interface. The CU-CP 172A can connect to one or more DU 174s through an F1-C interface. The CU-UP 172B can connect to one or more DU 174 through the F1-U interface under the control of the same CU-CP 172A. In some implementations, one DU 174 can connect to multiple CU-UP 172B under the control of the same CU-CP 172A. In such implementations, the connectivity between a CU-UP 172B and a DU 174 is established by the CU-CP 172A using Bearer Context Management functions.

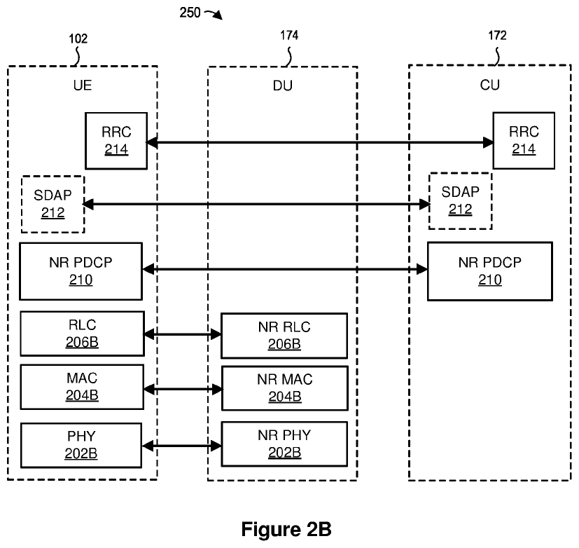

FIG. 2A illustrates, in a simplified manner, an example protocol stack 200 according to which the UE 102 can communicate with an eNB/ng-eNB or a gNB (e.g., one or more of the base stations 104, 106).

In the example stack 200, a physical layer (PHY) 202A of EUTRA provides transport channels to the EUTRA MAC sublayer 204A, which in turn provides logical channels to the EUTRA RLC sublayer 206A. The EUTRA RLC sublayer 206A in turn provides RLC channels to an EUTRA PDCP sublayer 208 and, in some cases, to an NR PDCP sublayer 210. Similarly, the NR PHY 202B provides transport channels to the NR MAC sublayer 204B, which in turn provides logical channels to the NR RLC sublayer 206B. The NR RLC sublayer 206B in turn provides data transfer services to the NR PDCP sublayer 210. The NR PDCP sublayer 210 in turn can provide data transfer services to Service Data Adaptation Protocol (SDAP) 212 or a radio resource control (RRC) sublayer (not shown in FIG. 2A). The UE 102, in some implementations, supports both the EUTRA and the NR stack as shown in FIG. 2A, to support handover between EUTRA and NR base stations and/or to support DC over EUTRA and NR interfaces. Further, as illustrated in FIG. 2A, the UE 102 can support layering of NR PDCP 210 over EUTRA RLC 206A, and SDAP sublayer 212 over the NR PDCP sublayer 210.

The EUTRA PDCP sublayer 208 and the NR PDCP sublayer 210 receive packets (e.g., from an Internet Protocol (IP) layer, layered directly or indirectly over the PDCP layer 208 or 210) that can be referred to as service data units (SDUs), and output packets (e.g., to the RLC layer 206A or 206B) that can be referred to as protocol data units (PDUs). Except where the difference between SDUs and PDUs is relevant, this disclosure for simplicity refers to both SDUs and PDUs as “packets.”

On a control plane, the EUTRA PDCP sublayer 208 and the NR PDCP sublayer 210 can provide signaling radio bearers (SRBs) or RRC sublayer (not shown in FIG. 2A) to exchange RRC messages or non-access-stratum (NAS) messages, for example. On a user plane, the EUTRA PDCP sublayer 208 and the NR PDCP sublayer 210 can provide Data Radio Bearers (DRBs) to support data exchange. Data exchanged on the NR PDCP sublayer 210 can be SDAP PDUs, Internet Protocol (IP) packets or Ethernet packets.

FIG. 2B illustrates, in a simplified manner, an example protocol stack 250, which the UE 102 can communicate with a DU (e.g., DU 174) and a CU (e.g., CU 172). The radio protocol stack 200 is functionally split as shown by the radio protocol stack 250 in FIG. 2B. The CU at any of the base stations 104 or 106 can hold all the control and upper layer functionalities (e.g., RRC 214, SDAP 212, NR PDCP 210), while the lower layer operations (e.g., NR RLC 206B, NR MAC 204B, and NR PHY 202B) are delegated to the DU. To support connection to a 5GC, NR PDCP 210 provides SRBs to RRC 214, and NR PDCP 210 provides DRBs to SDAP 212 and SRBs to RRC 214.

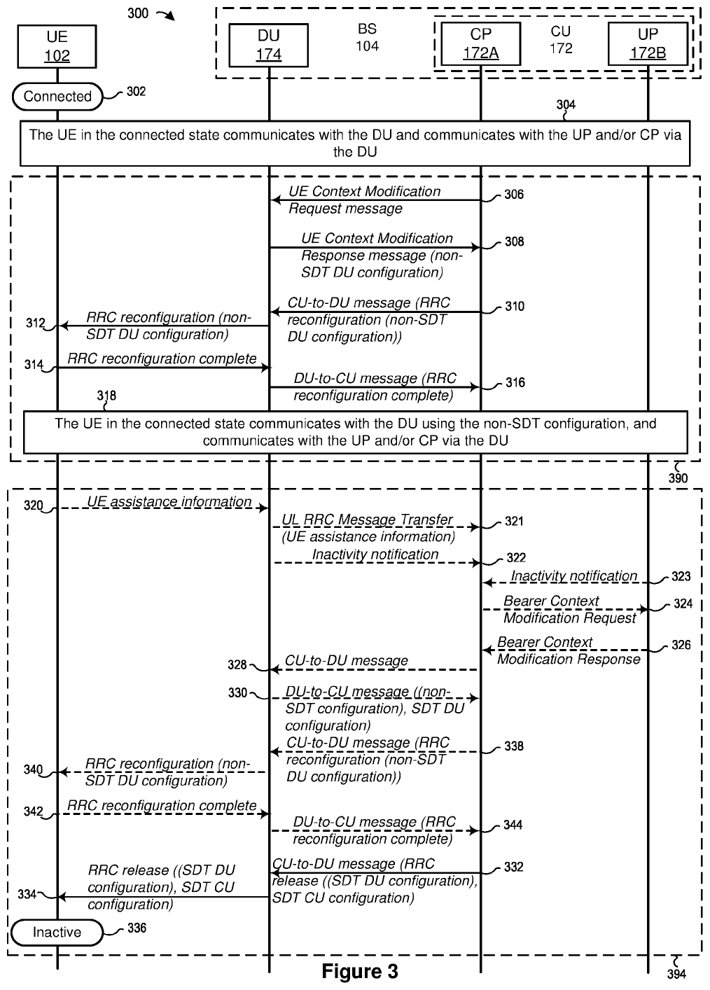

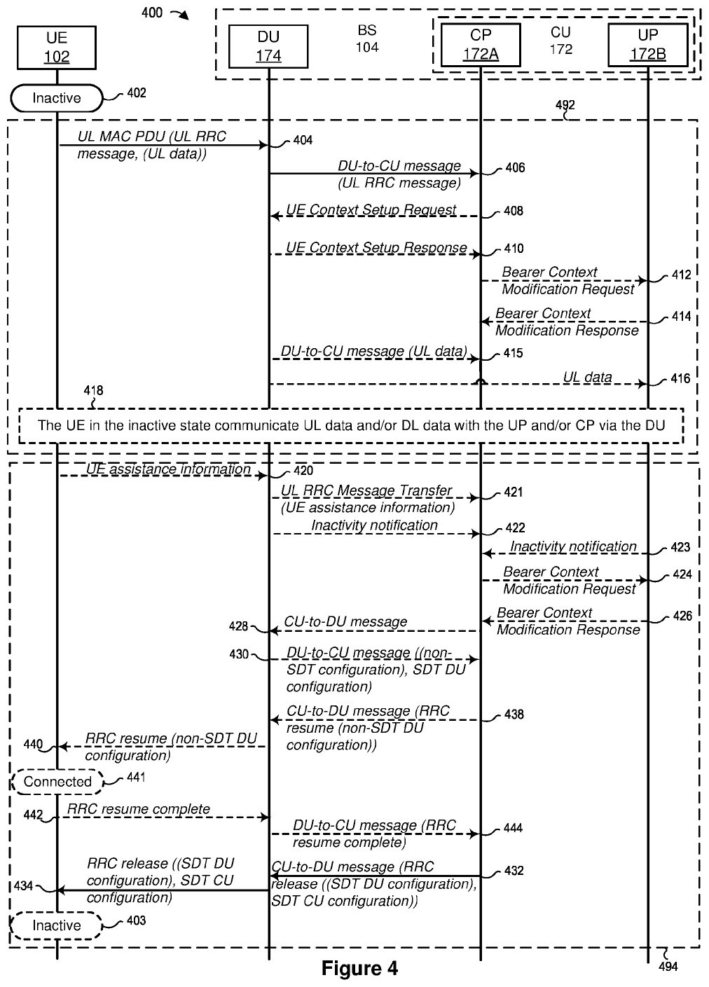

Next, several example scenarios that involve several components of FIG. 1A and relate to transmitting data in an inactive or idle state are discussed next with reference to FIGS. 3 and 4. To simplify the following description, the term “inactive state” is used and can represent the RRC_INACTIVE or RRC_IDLE state, and the “connected state” is used and can represent the RRC_CONNECTED state.

Referring first to FIG. 3, in a scenario 300, the base station 104 includes a central unit (CU) 172 and a distributed unit (DU) 174, and the CU 172 includes a CU-CP 172A and a CU-UP 172B. In this scenario 300, the UE 102 initially operates in a connected state 302 and communicates 304 with the DU 174 using a DU configuration (i.e., a first non-SDT DU configuration). The UE 102 further communicates 304 with the CU-CP 172A and/or CU-UP 172B via the DU 174 using a CU configuration (i.e., a first non-SDT CU configuration). In some implementations, while the UE 102 communicates 304 with the base station 104, the CU-CP 172A sends 306 a UJE Context Modification Request message to the DU 174. In response, the DU 174 sends 308 a UE Context Modification Response message, including a non-SDT DU configuration (i.e., a second non-SDT DU configuration) for the UE 102, to the CU-CP 172A. The CU-CP 172A generates an RRC reconfiguration message including the second non-SDT DU configuration and transmits 310 a first CU-to-DU message (e.g., DI. RRC Message Transfer message), including the RRC reconfiguration message, to the DU 174. In turn, the DU 174 transmits 312 the RRC reconfiguration message to the UE 102. In response, the UE 102 transmits 314 an RRC reconfiguration complete message to the DU 174, which in turn transmits 316 a first DU-to-CU message (e.g., UL RRC Message Transfer message) including the RRC reconfiguration complete message to the CU-CP 172A.

After receiving 312 the RRC reconfiguration message, the UE 102 in the connected state communicates 318 with the DU 174 using the second non-SDT DU configuration and communicates with the CU-CP 172A and/or CU-UP 172B via the DU 174. In cases where the RRC reconfiguration message does not include a CU configuration, the UE 102 communicates 318 with the CU-CP 172A and/or CU-UP 172B via the DU 174 using the first non-SDT CU configuration. In cases where the RRC reconfiguration message includes a non-SDT CU configuration (i.e., a second non-SDT CU configuration), the UE 102 communicates 318 with the CU-CP 172A and/or CU-UP 172B via the DU 174, using the second non-SDT CU configuration. In some implementations, the second non-SDT CU configuration augments the first non-SDT CU configuration or include at least one new configuration parameter not included in the first non-SDT CU configuration. In some such cases, the UE 102 and the CU-CP 172A and/or the CU-UP 172B communicate 318 with one another using the second non-SDU CU configuration and the configuration parameters in the first non-SDT CU configuration that the second non-SDU CU configuration did not augment. In some implementations, the first non-SDT CU configuration includes configuration parameters, related to operations of RRC and/or PDCP protocol layers (e.g., RRC 214 and/or NR PDCP 210), that the UE 102 and CU 172 use to communicate with one another while the UE 102 operates in the connected state. Similarly, depending on the implementation, the second non-SDT CU configuration includes configuration parameters, related to operations of the RRC and/or PDCP protocol layers, that the UE 102 and CU 172 use to communicate with one another while the UE 102 operates in the connected state. In some implementations, the first non-SDT CU configuration includes configuration parameters in a RadioBearerConfig information element (IE) and/or MeasConfig 1E (e.g., as defined in 3GPP specification 38.331 v16.7.0). Similarly, the second non-SDT CU configuration includes configuration parameters in the RadioBearerConfig 1E and/or MeasConfig 1E (e.g., as defined in 3GPP specification 38.331 v16.7.0). In some implementations, the first non-SDT CU configuration is or includes a RadioBearerConfig 1E and/or a MeasConfig 1E, and the second non-SDT CU configuration is or includes a RadioBearerConfig 1E and/or MeasConfig 1E.

In some implementations, the second non-SDT DU configuration augments the first non-SDT DU configuration or includes at least one new configuration parameter not included in the first non-SDT DU configuration. In some such cases, the UE 102 and the DU 174 communicates 318 with one another using the second non-SDU DU configuration and the configuration parameters in the first non-SDT DU configuration that the second non-SDU DU configuration did not augment. In some implementations, the first non-SDT DU configuration includes configuration parameters, related to operations of RRC, RLC, MAC, and/or PHY protocol layers (e.g., RLC 206B, MAC 204B, and/or PHY 202B), that the UE 102 and DU 174 use to communicate with one another while the UE 102 operates in the connected state. Similarly, depending on the implementation, the second non-SDT DU configuration includes configuration parameters, related to operations of the RRC, RLC, MAC, and/or PHY protocol layers, that the UE 102 and DU 174 use to communicate with one another while the UE 102 operates in the connected state. In some implementations, the first non-SDT DU configuration includes configuration parameters in a CellGroupConfig 1E (e.g., as defined in 3GPP specification 38.331 v16.7.0). Similarly, the second non-SDT DU configuration includes configuration parameters in the CellGroupConfig 1E (e.g., as defined in 3GPP specification 38.331 v16.7.0). In some implementations, the first non-SDT DU configuration and the second non-SDT DU configuration are CellGroupConfig 1Es.

The events 306, 308, 310, 312, 314, 316 and 318 are collectively referred to in FIG. 3 as a non-SDT resource (re) configuration procedure 390.

In some implementations, while the UE 102 communicates with the base station 104, or after the non-SDT resource (re) configuration procedure 390, the CU-CP 172A determines to cause the UE 102 to transition to an inactive state from the connected state based on data inactivity of the UE 102 (i.e., based on the UE 102 in the connected state having no data activity with the base station 104). In some implementations, while the UE 102 communicates with the base station 104 or after the non-SDT resource (re) configuration procedure 390, the UE 102 determines or detects data inactivity and transmits 320, to the DU 174, UE assistance information (e.g., a UEAssistanceInformation message) indicating that the UE 102 prefers or requests to transition to the inactive state with SDT configured. In turn, the DU 174 transmits 321 a UL RRC Message Transfer message including the UE assistance information to the CU-CP 172A. Thus, in some such implementations, the CU-CP 172A determines that the UE 102 is in a data inactivity state based on the UE assistance information. In other implementations, the DU 174 performs data inactivity monitoring for the UE 102. In further implementations, the CU-CP 172A transmits a CU-to-DU message (e.g., a (JE Context Setup Request message or a UE Context Modification Request message) to the DU 174 to request or command the DU 174 to perform the data inactivity monitoring, for example. In some cases where the DU 174 detects or determines that the UE 102 is in a data inactivity state during the monitoring, the DU 174 transmits 322 an inactivity notification (e.g., a UE Inactivity Notification message) to the CU-CP 172A. Thus, in some such implementations, the CU-CP 172A determines that the UE 102 is in a data inactivity state based on the inactivity notification received from the DU 174. In yet other implementations, the CU-UP 172B performs data inactivity monitoring for the UE 102. The CU-CP 172A transmits a CP-to-UP message (e.g., a Bearer Context Setup Request message or a Bearer Context Modification Request message) to the CU-UP 172B to request or command the CU-UP 172B to perform the data inactivity monitoring, for example. In some cases where the CU-UP 172B detects or determines that the UE 102 is in a data inactivity state during the monitoring, the CU-UP 172B transmits 323 an inactivity notification (e.g., a Bearer Context Inactivity Notification message) to the CU-CP 172A. Thus, the CU-CP 172A determines that the UE 102 is in a data inactivity state based on the inactivity notification received from the CU-UP 172B. In some implementations, the CU-CP 172A determines that the UE 102 is in a data inactivity state based on any combination of the UE assistance information, the inactivity notification of the event 322, and/or the inactivity notification of the event 323.

After a certain period of data inactivity, the CU-CP 172A determines that the CU 172 and the UE 102 have not transmitted any data in the downlink direction or the uplink direction, respectively, during the certain period (e.g., using any of the techniques described above for the UE inactivity determination). In some implementations, in response to the determination, the CU-CP 172A determines to cause the UE 102 to transition to the inactive state with SDT configured. Alternatively, the CU-CP 172A determines to immediately cause the UE 102 to transition to the inactive state with SDT configured in response to determining that the UE 102 is in a data inactivity state, irrespective of whether the CU 172 has transmitted data in the downlink direction in any particular time period.

In response to or after determining that the UE 102 is in a data inactivity state (for the certain period) or otherwise in response to determining to cause the UE 102 to transition to the inactive state with SDT configured, the CU-CP 172A sends 324, to the CU-UP 172B, a Bearer Context Modification Request message to suspend data transmission for the UE 102. In response, the CU-UP 172B suspends data transmission for the UE 102 and sends 326 a Bearer Context Modification Response message to the CU-CP 172A. Also in response to or after determining that the UE 102 is in a data inactivity state (for the certain period) or otherwise in response to determining to cause the UE 102 to transition to the inactive state with SDT configured, the CU-CP 172A sends 328 a second CU-to-DU message (e.g., a UE Context Modification Request message) to instruct the DU 174 to provide (i.e., request from the DU 174) an SDT DU configuration for the UE 102. In some implementations, the CU-CP 172A includes an SDT request indication (e.g., a field, an IE, or a CG-SDT Query Indication) to request an SDT DU configuration in the second CU-to-DU message. In response to the SDT request indication or the second CU-to-DU message, the DU 174 transmits 330 a second DU-to-CU message (e.g., UE Context Modification Response message) that includes a first SDT DU configuration to the CU-CP 172A. Alternatively, the DU 174 does not include an SDT DU configuration in the second DU-to-CU message, and the DU 174 instead sends, to the CU-CP 172A, another DU-to-CU message (e.g., UJE Context Modification Required message), including the first SDT DU configuration, after receiving the second CU-to-DU message (event 328) and/or after transmitting the second DU-to-CU message (event 330). In some alternative implementations, the CU-CP 172A transmits the second CU-to-DU message and receives the second DU-to-CU message (or receives the alternative DU-to-CU message discussed above) before determining that the UE 102 is in a data inactivity state.

In some implementations, the DU 174 includes a third non-SDT DU configuration in the second DU-to-CU message. In such implementations, the CU-CP 172A generates an RRC reconfiguration message including the third non-SDT DU configuration and sends 338, to the DU 174, an additional CU-to-DU including the RRC reconfiguration message. In turn, the DU 174 transmits 340 the RRC reconfiguration message to the UE 102. In response, the UE 102 transmits 342 an RRC reconfiguration complete message to the DU 174, which in turn transmits 344 an additional DU-to-CU message (e.g., UL RRC Message Transfer message), including the RRC reconfiguration complete message, to the CU-CP 172A. In some implementations, the DU 174 includes the first SDT DU configuration in an IE (e.g., DU to CU RRC Information IE) of the second DU-to-CU message. In such implementations the DU 174 includes a non-SDT DU configuration according to a format of the IE, so that the DU 174 includes the third non-SDT DU configuration in the IE.

In some implementations, the third non-SDT DU configuration augments the first and/or second non-SDT DU configurations or includes at least one new configuration parameter not included in the first and/or second non-SDT DU configurations. In some such cases, the UE 102 in the connected state and the DU 174 communicate with one another using the third non-SDU DU configuration and the configuration parameters in the first and/or second non-SDT DU configurations that the third non-SDU DU configuration did not augment. In some implementations, the third non-SDT DU configuration includes configuration parameter(s) included in the first and/or second non-SDT DU configurations, and the DU 174 sets the configuration parameter(s) to the same value(s) in the first and/or second non-SDT DU configurations. Depending on the implementation, the DU 174 includes or does not include configuration parameter(s) to augment the first and/or second non-SDT DU configurations. Similarly, depending on the implementation, the DU 174 includes or does not include at least one new configuration parameter not included in the first and/or second non-SDT DU configurations.

In other implementations, the DU 174 includes an indication to ignore or discard the third non-SDT DU configuration in the second DU-to-CU message of event 330. In response to the indication, the CU 172 discards the third non-SDT DU configuration. Thus, the events 338, 340, 342 and 344 are omitted. For example, the indication is a non-SDT configuration ignorance indication or a cell group configuration (CellGroupConfig) ignorance indication.

In yet other implementations, the DU 174 generates the third non-SDT DU configuration as a special non-SDT DU configuration. For example, the special non-SDT DU configuration is an empty non-SDT DU configuration that neither (i) includes configuration parameters to augment the first and/or second non-SDT DU configurations, nor (ii) includes a new configuration parameter not included in the first and/or second non-SDT DU configurations. In some such examples, the special non-SDT DU configuration includes a cell group ID, empty IE(s), and/or configuration parameter(s) that have been configured for the UE 102 or transmitted to the UE 102. The empty IE(s) includes no configuration parameters. In another example, the special non-SDT DU configuration is a zero-length non-SDT DU configuration or a zero-length octet string. In some implementations, the CU 172 determines to transmit the special non-SDT DU configuration to the UE 102 via the DU 174 at the events 338 and 340. In other implementations, the CU 172 determines to ignore or discard the special non-SDT DU configuration. Thus, the events 338, 340, 342 and 344 are omitted.

In some implementations, the DU 174 determines to use at least one configuration parameter for the UE 102 to perform SDT, and the at least one configuration parameter is not supported by the first SDT DU configuration. In such cases, the DU 174 includes the at least one configuration parameter in the third non-SDT DU configuration. For example, the configuration parameter includes RLC bearer configuration parameter(s), logical channel configuration parameter(s), and/or MAC configuration parameter(s), and/or PHY configuration parameter(s). In some implementations, the DU 174 refrains from including MAC configuration parameter(s) and/or PHY configuration parameter(s) in the third non-SDT DU configuration.

In some implementations, the third non-SDT DU configuration includes configuration parameters in a CellGroupConfig 1F (e.g., as defined in 3GPP specification 38.331 v17.0.0). In some implementations, the third non-SDT DU configuration is a CellGroupConfig 1E including the configuration parameters. In some implementations, the RLC bearer configuration parameter(s) are RIC-BearerConfig 1E(s) or include configuration parameter(s) in the RIC-BearerConfig 1E. In some implementations, the logical channel configuration parameter(s) are LogicalChannelConfig 1E(s) or include configuration parameter(s) (e.g., logical (hannelGroup, logicalChannelSR-Delay TimerApplied, and logicalChannelSR-Mask) in the LogicalChannelConfig 1E. In some implementations, the MAC configuration parameter(s) are MAC-CellGroupConfig 1E(s) or include configuration parameter(s) (e.g., enhancedSkipUplinkTxDynamic, SkipUplinkTxDynamic, enhancedSkipUplinkTxConfigured, buffer status reporting (BSR) configuration, and/or a power headroom reporting (PHR) configuration) in the MAC-CellGroupConfig 1E. In some implementations, the PHY configuration parameters are PhysicalCellGroupConfig 1E(s) or include configuration parameter(s) (e.g., a configured scheduling RNTI (CS-RNTI)) in the PhysicalCellGroupConfig 1E.

In some implementations, the DU 174 refrains from including a non-SDT DU configuration (e.g., CellGroupConfig 1E) in the second DU-to-CU message. Thus, the DU 174 does not include the third non-SDT DU configuration in the second DU-to-DU message. In some implementations, the DU 174 includes the first SDT DU configuration in an existing or new IE of the second DU-to-CU message instead of the IE (e.g., the DU to CU RRC Information IE) of the second DU-to-CU message. A format of the existing or new IE does not include a non-SDT DU configuration (e.g., CellGroupConfig 1E), so that the DU 174 does not include a non-SDT DU configuration (e.g., CellGroupConfig 1E) in the second DU-to-CU message. In other implementations, the DU 174 artificially excludes a non-SDT DU configuration (e.g., CellGroupConfig 1E) from the IE (e.g., the DIJ to CUI RRC Information IE) of the second DU-to-CU message when the DU 174 determines not to augment the first and/or second non-SDT DU configurations or not send a new non-SDT configuration parameter to the UE 102.

In some implementations, in response to determining to cause the UE 102 to transition to the inactive state with SDT configured, the CU-CP 172A generates an RRC release message (e.g, RR (Release message or RR (ConnectionRelease message) to cause the UF. 102 to transition to the inactive state. In cases where the CU-CP 172A transmits 338 the RRC reconfiguration, the CU-CP 172A transmits the RRC release message after transmitting 338 the RRC reconfiguration message or receiving 344 the RRC reconfiguration complete message. In some implementations, the CU-CP 172A includes the first SDT DU configuration in the RRC release message. In further implementations, the CU-CP 172A additionally includes a first SDT CU configuration in the RRC release message. The CU-CP 172A then sends 332, to the DU 174, a third CU-to-DU message (e.g., a IJE Context Release Command message or a UE Context Modification Request message) which includes the RRC release message. In turn, the DU 174 transmits 334 the RRC release message to the UE 102. In some implementations, the DU 174 receives (e.g., at event 332) a DL PDCP PDU including the RRC release message from the CU-CP 172A The DU 174 generates a DI, RLC PDU including the DI, PDCP PDU, generates a DI MAC PDU including the DL RLC PDU, and transmits 334 the DL MAC PDU to the UE 102. In some implementations, the DU 174 determines that the UE 102 receives the RRC release message upon receiving a HARQ ACK for the DL MAC PDU from the UE 102. In yet other implementations, the DU 174 determines that the UE 102 receives the RRC release message upon receiving an RLC ACK for the DL RLC PDU from the UE 102. In yet other implementations, the DU 174 starts a release timer in response to transmitting or determining to transmit the RRC release message. When the release timer expires, the DU 174 determines that the UE 102 receives the RRC release message.

The RRC release message instructs the UE 102 to transition to the inactive state. The UE 102 transitions 336 to the inactive state from the connected state upon receiving the RRC release message. In some implementations, in response to or after receiving the third CU-to-DU message, the DU 174 retains the first SDT DU configuration. In some implementations, the DU 174 releases the first non-SDT DU configuration and/or second non-SDT DU configuration in response to or after receiving the third CU-to-DU message. In other implementations, the DU174 retains the first non-SDT DU configuration and/or second non-SDT DU configuration in response to or after receiving the third CU-to-DU message. In yet other implementations, the DU 174 retains a portion of the first non-SDT DU configuration and/or second non-SDT DU configuration and releases the rest of the first non-SDT DU configuration and/or second non-SDT DU configuration in response to or after receiving the third CU-to-DU message. For example, the DU 174 retains the RLC bearer configuration parameter(s), logical channel configuration parameter(s) configuration parameter(s), MAC configuration parameter(s), and/or PHY configuration parameter(s) (e.g., the CS-RNTI). In some implementations, the DU 174 sends a third DU-to-CU message (e.g., a (IE Context Release Complete message or a UJE Context Modification Response message) to the CU-CP 172A in response to the third CU-to-DU message.

In some implementations, the UE 102 releases at least a portion of the first non-SDT DU configuration, second non-SDT DU configuration, and/or the third non-SDT DU configuration in response to the RRC release message. In other implementations, if the RRC release message instructs the UE 102 to transition to an idle state (i.e., RRC_IDLE), the UE 102 releases the first non-SDT DU configuration, second non-SDT DU configuration, and/or third non-SDT configuration. In yet other implementations, if the RRC release message instructs the UE to transition to the inactive state (i.e., RRC_INACTIVE), the UE 102 releases a first portion of the first, second, and/or third non-SDT DU configurations and retains a second portion of the first, second, and/or third non-SDT DU configurations.

In some implementations, the CU-CP 172A does not include an indication in the third CU-to-DU message to instruct the DU 174 to retain the first SDT DU configuration, but the DU 174 nonetheless retains the first SDT DU configuration as described above. In further implementations, the CU-CP 172A includes an indication in the third CU-to-DU message to instruct the DU 174 to retain the first SDT DU configuration, and the DU 174 retains the first SDT DU configuration in response to the indication. The DU 174 retains at least a portion of the first, second, and/or non-SDT DU configurations. In such implementations, if the DU 174 receives, from the CU-CP 172A, a UE Context Release Command message for the UE 102 excluding the indication, the DU 174 releases the first SDT DU configuration and the first, second, and/or third non-SDT DU configurations.

In some implementations, the first SDT CU configuration includes a DRB list (e.g., a std-DRB-List) including a list of DRB ID(s) indicating ID(s) of DRB(s) configured for SDT. In further implementations, the first SDT CU configuration includes an SRB2 indication (e.g., sdt-SRB2-Indication) indicating an SRB2 configured for SDT. In still further implementations, the first SDT CU configuration includes a compression protocol continue indication (e.g., sdt-DRB-ContinueROHC) indicating whether a PDCP entity for the DRB(s) configured for SDT, during SDT operation (i.e., initial and/or subsequent SDT as described in FIG. 4), continues. In yet further implementations, the first SDT CU configuration includes a data volume threshold (e.g., sdt-DataVolume Threshold) for the UE 102 to determine whether SDT can be initiated.

In some implementations, the first SDT DU configuration includes at least one common SDT configuration, at least one RA-SDT configuration, and/or at least one CG-SDT configuration for CG-SDT. For example, the at least one common SDT configuration includes a buffer status reporting (BSR) configuration and/or a power headroom reporting (PHR) configuration. In another example, the at least one RA-SDT configuration includes random access configuration parameters for two-step and/or four-step random access procedures. In another example, the at least one CG-SDT configuration includes CG-SDT configuration parameters (e.g., a CS-RNTI) for CG-SDT, a configured grant (CG) configuration (e.g., ConfiguredGrantConfig 1E) for CG-SDT, a time alignment timer value for CG-SDT, and/or a timing advance validity threshold. The CG configuration configures a configured grant periodically occurring in time domain (e.g., CG occasions such as slots). In some implementations, the CG configuration includes configuration parameters for frequency hopping, demodulation reference signal (DMRS), modulation and coding scheme (MCS), transport block size (TBS), resource allocation, resource block group, CG timer, frequency domain resource allocation, HARQ operation, mapping pattern, path loss reference, physical uplink shared channel (PUSCH), periodicity, power control, precoding and number of layers for multiple input multiple output (MIMO), time domain offset, and/or time domain allocation. In yet another example, the CG-SDT configuration is an SDT-MAC-PHY-CG-Config 1E or include CG-SDT configuration parameters in the SDT-MAC-PHY-CG-Config 1E. In some implementations, the DU 174 configures the timing advance validity threshold for the UE 102 to determine whether the UE 102 performs SDT using the configured grant configuration for CG-SDT. In further implementations, in accordance with the timing advance validity threshold, the UE 102 evaluates whether a stored timing advance value is still valid. If the UE 102 determines that the stored timing advanced value is invalid or CG-SDT is not suitable, the UE 102 performs an RA-SDT with the CU 172 via the DU 174 as described with regard to FIG. 4.

In cases where the DU 174 provides the CG-SDT configuration to the CU-CP 172A at event 330, the DU 174 retains radio resources configured by the CG-SDT configuration while retaining the first SDT DU configuration. After transmitting 330 the second DU-to-CU message, receiving 332 the third CU-to-DU message, transmitting 334 the RRC release message, receiving the HARQ ACK or RLC ACK for the RRC release message from the UE 102, or the release timer expires, the DU 174 starts or attempts to receive, from the UE 102, UL transmission(s) on radio resources configured in a configured grant (CG) configuration for SDT in the CG-SDT configuration. In some implementations, the DU 174 releases radio resources configured by the CG-SDT configuration when releasing the first SDT DU configuration or the CG-SDT configuration. In cases where the DU 174 does not provide the CG-SDT configuration to the CU-CP 172A, the DU 174 releases all related signaling and user data transport resources for the UE 102 in response to the third CU-to-DU message. In cases where the DU 174 provides the CG-SDT configuration to the CU-CP 172A, the DU 174 retains all related signaling and user data transport resources for the UE 102 in response to or after receiving the third CU-to-DU message.

In cases where the first SDT DU configuration does not include a configuration for CG-SDT, the CU-CP 172A and/or the DU 174 only configures RA-SDT for the UE 102. In some such cases, the UE 102 performs RA-SDT with the CU 172 via the DU 174 as described with regard to FIG. 4.

In some implementations, the CU-CP 172A does not request the DU 174 to provide an SDT DU configuration for causing the UE 102 to transition to the inactive state with SDT configured. In some such cases, the events 328 and 330 are omitted, and the CU-CP 172A does not include an SDT DU configuration in the RRC release message. Instead, in some such implementations, the CU-CP 172A generates the first SDT DU configuration by itself without requesting the DU 174 to provide an SDT DU configuration and includes the first SDT DU configuration in the RRC release message.

In some implementations, the DU 174 does not include an SDT DU configuration in the second DU-to-CU message (e.g., if or because the UE 102 does not support CG-SDT, the DU 174 does not support CG-SDT, or the DU 174 does not have available radio resources for CG-SDT). In some such cases, the RRC release message does not include an SDT DU configuration Otherwise, the DU 174 includes the first SDT DU configuration as described above. In some implementations, the DU 174 does not include a CG-SDT configuration in the first SDT DU configuration in the second DU-to-CU message (e.g., if or because the UE 102 does not support CG-SDT, the DU 174 does not support CG-SDT, or the DU 174 does not have available radio resources for CG-SDT). In some such cases, the first SDT DU configuration does not include a CG-SDT configuration. Otherwise, the DU 174 includes the at least one CG-SDT configuration in the first SDT DU configuration as described above.

In some implementations, the CU-CP 172A requests the DU 174 to provide an SDT DU configuration as described above, such as in cases where the UE 102 supports CG-SDT and/or the DU 174 supports CG-SDT. In cases where the UE 102 does not support CG-SDT or the DU 174 does not support CG-SDT, the CU-CP 172A does not request the DU 174 to provide an SDT DU configuration. In some implementations, the CU-CP 172A receives a UE capability (e.g., UE-NR-Capability IE) of the UE 102 from the UE 102, the CN 110 (e.g., MME 114 or AMF 164), or the base station 106 while the UE 102 operates 302 in the connected state. The UE capability indicates whether the UE 102 supports CG-SDT. Thus, the CU-CP 172A can determine whether the UE 102 supports CG-SDT in accordance with the UE capability. In some implementations, the CU-CP 172A receives, from the DU 174, a DU-to-CU message indicating whether the DU 174 supports CG-SDT. Depending on the implementation, the DU-to-CU message is the second DU-to-CU message, the message of the event 308 or 316, or a non-UE associated message (e.g., a non-UE associated F1AP message (e.g., as defined in 3GPP specification 38.473)).

In some implementations, the DU 174 determines whether to provide an SDT DU configuration for the UE 102 to the CU-CP 172A, based on whether the UE 102 supports CG-SDT or not. In further implementations, in addition to whether the UE 102 supports CG-SDT or not, the DU 174 additionally determines whether to provide an SDT DU configuration for the UE 102 to the CU-CP 172A based on whether the DU 174 supports CG-SDT or not. In cases where the UE 102 supports CG-SDT and/or the DU 174 supports CG-SDT, the DU 174 provides the first SDT DU configuration for the UE 102 to the CU-CP 172A as described above. In cases where the UE 102 does not support CG-SDT or the DU 174 does not support CG-SDT, the DU 174 does not provide an SDT DU configuration for the UF 102 (eg, the DU 174 does not include the first SDT DU configuration in the second DU-to-CU message). The DU 174 receives the UE capability from the CU-CP 172A, while the UE 102 operates 302 in the connected state or in the inactive state before the event 302. Thus, the DU 174 can determine whether the UE 102 supports CG-SDT in accordance with the UE capability. In some implementations, the DU 174 sends a DU-to-CU message to the CU-CP 172A to indicate whether the DU 174 does support CG-SDT or not as described above.

The events 320, 321, 322, 323, 324, 326, 328, 330, 338, 340, 342, 344, 332, 334, and 336 are collectively referred to in FIG. 3 as an SDT configuration procedure 394.

Referring next to FIG. 4, a scenario 400 depicts small data transmission. In the scenario 400, the base station 104 includes a CU 172 and a DU 174. The CU 172 includes a CU-CP 172A and a CU-UP 172B. In the scenario 400, the UE 102 initially operates 402 in an inactive state with SDT configured. In some implementations or scenarios, prior to the events shown in FIG. 4, the UE 102 transitions to the inactive state with SDT configured from the connected state as described for FIG. 3 (i.e., event 402 can follow event 336). In other implementations or scenarios, prior to the events shown in FIG. 4, the UE 102 transitions to the inactive state with SDT configured from the inactive state without SDT configured. For example, the UE 102 receives, from a base station (e.g., the base station 104 or base station 106), an RRC release message, causing the UE 102 to transition to the inactive state and not including an SDT configuration. In such cases, the UE 102 transitions to the inactive state without SDT configured in response to the RRC release message. In some implementations, the UE 102 in the inactive state, with or without SDT configured, performs a RAN notification area (RNA) update with the base station without state transitions. During the RNA update, the UE 102 receives another RRC release message, including a first SDT CU configuration and/or a first SDT DU configuration from the base station, similar to the RRC release message of the event 334.

Later in time, the UE 102, operating in the inactive state with SDT configured, initiates SDT (e.g., SDT session or procedure). In response to or after initiating SDT, the UE 102 generates an initial UL MAC PDU, which includes a UL RRC message, and transmits 404 the initial UL MAC PDU to the DU 174 on the cell 124. In some implementations, the UE 102 starts an SDT session timer (e.g., timer T319a) in response to or after initiating the SDT. In some implementations, the UF 102 starts the SDT session timer upon initiating the SDT. In other implementations, the UE 102 starts the SDT session timer after transmitting 404 the initial UL MAC PDU. The DU 174 retrieves the UL RRC message from the initial UL MAC PDU, generates a first DU-to-CU message including the UL RRC message, and sends 406 the first DU-to-CU message to the CU-CP 172A. In some implementations, the first DU-to-CU message is an Initial UL. RRC Message Transfer message. In other implementations, the first DU-to-CU message is a III. RRC Message Transfer message.

In scenarios in which the UE 102 initiates SDT to transmit UL data (e.g., a data packet) qualifying for SDT, the UE 102 includes the UL data in the initial UL MAC PDU that the UE 102 transmits 404. In scenarios in which the UE 102 initiates SDT to receive DL data, the UE 102 does not include a UL data packet in the initial UL MAC PDU that the UE 102 transmits 404. In further implementations, the UE 102 initiates SDT to receive DL data in response to receiving a paging from the DU 174. In some such scenarios, the UE 102 includes an SDT indication in the initial UL MAC PDU or the UL RRC message to indicate to the base station 104 that the UE 102 is initiating SDT to receive DL data.

In some implementations, the UE 102 includes a buffer status report or a power headroom report in the initial UL MAC PDU of the event 404. In other implementations, the UE 102 refrains from including a buffer status report and/or a power headroom report in the initial UL MAC PDU of the event 404 (e.g., in accordance with the BSR configuration and/or PHR configuration, respectively). Depending on the implementation, in the buffer status report, the UE 102 includes or indicates a buffer status of the UE 102 for one or more logical channels or logical channel groups. In further implementations, in the power headroom report, the UE 102 includes or indicates power headroom status or value.

In some implementations, the UE 102 in the inactive state performs a random access procedure with the DU 174 to transmit 404 the initial UL MAC PDU. In such cases, the SDT is an RA-SDT. For example, the random access procedure is a four-step random access procedure or a two-step random access procedure. In the case of the four-step random access procedure, the UE 102 transmits a random access preamble to the DU 174, and, in response, the DU 174 transmits to the UE 102 a random access response (RAR) including an uplink grant. Further, the UE 102 transmits 404 the initial UL MAC PDU in accordance with the uplink grant. The DU 174 receives 404 the initial UL MAC PDU in accordance with the uplink grant in the RAR. In the case of the two-step random access procedure, the UE 102 transmits 404 to the DU 174 a message A including a random access preamble and the initial UL MAC PDU in accordance with two-step random access configuration parameters. The UE 102 receives the two-step random access configuration parameters in system information broadcast by the DU 174 on the cell 124 before transmitting 404 the initial UL MAC PDU. The DU 174 receives 404 the initial UL MAC PDU in accordance with the two-step random access configuration parameters.

In further implementations, the UE 102 transmits 404 the initial UL MAC PDU on radio resources configured in a configured grant (CG) configuration for SDT, such as in cases where the UE 102 received a CG-SDT configuration, as described with regard to FIG. 3. Thus, the DU 174 receives 404 the UL MAC PDU on the radio resources in accordance with the CG configuration. In some such implementations, the UE 102 transmits (e.g., at event 418) subsequent UL MAC PDU(s) including one or more UL data packets, discussed below, on radio resources configured in the CG configuration.

In some implementations, if the DU 174 fails to obtain the initial UL MAC PDU at event 404, the DU 174 commands the UE 102 to retransmit the initial UL MAC PDU. More specially, the DU 174 generates a DCI including a UL grant (i.e., dynamic grant), generates a CRC for the DCI, scrambles the CRC with an ID of the UE 102, and transmits the DCI and scrambled CRC on a PDCCH to command the UE 102 to retransmit the initial UL MAC PDU. The UE 102 receives the DCI and scrambled CRC on the PDCCH from the DU 174 and verifies whether the CRC is valid using the ID of the UE 102 and the DCI. If the UE 102 verifies that the CRC is valid using the ID of the UE 102, the UE 102 retransmits the initial UL MAC PDU to the DU 174 in accordance with the DCI. Otherwise, if the UE 102 verifies that the CRC is not valid, the UE 102 discards the DCI. In some implementations, if the DU 174 fails to obtain the initial UL MAC PDU from the retransmission of the initial UL MAC PDU, the DU 174 again commands the UE 102 to retransmit the initial UL MAC PDU in a similar manner as described above. In some implementations, the ID is a CS-RNTI. For example, the UE 102 receives the CS-RNTI from the base station 104 as described with regard to FIG. 3. In another example, the UE 102 receives an RRC resume message including the CS-RNTI from the base station 104 before initiating the SDT at event 404. In other implementations, the ID is a C-RNTI. In one implementation, the UE 102 receives an RRC reconfiguration message including the C-RNTI from the CU 172 via the base station 106 or another DU. In another implementation, the UE 102 performs a random access procedure with the DU 174 before initiating the SDT at event 404 and receives the C-RNTI from the DU 174 in a random access response or a message B (MSGB) in the random access procedure.

In some implementations, if the DU 174 successfully obtains the initial UL MAC PDU at event 404, the DU 174 commands the UE 102 to transmit or receive a new transmission. More specially, in some such implementations, the DU 174 generates a DCI, generates a CRC for the DCI, scrambles the CRC with an ID of the UE 102, and transmits the DCI and scrambled CRC on a PDCCH to command the UE 102 to transmit or receive a new transmission. If the UE 102 receives the DCI and scrambled CRC on the PDCCH from the DU 174 and verifies that the CRC is valid using the ID of the UF 102 and the DCI, the UF 102 determines that the DU 174 successfully receives the initial UL MAC PDU. In some implementations, the UE 102 starts the SDT session timer in response to the determination. In some implementations, the DCI includes a UL grant to command the UE 102 transmit a new transmission. In such cases, the UE 102 generates a UL MAC PDU and transmits the UL MAC PDU in accordance with the DCI. In cases where the UE 102 has UL data available for transmission, the UE 102 includes UL data in the UL MAC PDU. In some such cases, the UE 102 includes or does not include MAC control element(s) and subheader(s) for the MAC control element(s), and/or padding bits and a subheader for the padding bits in the UL MAC PDU. The MAC control element(s) include a BSR and/or a PHR. In some cases where the UE 102 has no UL data available for transmission, the UE 102 only includes MAC control element(s) and subheader(s) for the MAC control element(s), and/or padding bits and/or a subheader for the padding bits in the UL MAC PDU. In other implementations, the DCI includes a DL assignment to command the UE 102 to receive a new transmission. The DU 174 generates a DL MAC PDU and transmits the DL MAC PDU as a new transmission to the UE 102 in accordance with the DL assignment. The UE 102 receives the new transmission in accordance with the DCI and obtains the DL MAC PDU from the new transmission. In cases where the DU 174 receives DL data from the CU-CP 172A or CU-CP 172B, the DU 174 includes the DL data in the DL MAC PDU. In some such cases, the DU 174 includes or does not include padding bits and/or a subheader for the padding bits in the DL MAC PDU. In some cases where the DU 174 has no DL data available for transmission, the DU 174 only includes padding bits and/or a subheader for the padding bits in the DL MAC PDU.

If the UE 102 includes UL data in the initial UL MAC PDU, the DU 174 retrieves the UL data from the initial UL MAC PDU. In some such cases, the DU 174 includes the UL data in the DU-to-CU message of the event 406. Alternatively, the DU 174 sends the UL data to the CU-CP 172A separately, in a DU-to-CU message (i.e., event 415). In some implantations, the DU-to-CU message of event 415 is a UL RRC Message Transfer message. As yet another alternative, the DU 174 sends 416 the UL data to the CU-UP 172B separately via a user-plane (UP) connection as described below (i.e., event 416). After receiving 406 the first DU-to-CU message, the CU-CP 172A in some implementations sends 408 a UJE Context Setup Request message to the DU 174 to establish a UE Context of the UE 102 at the DU 174. In some implementations, in the UJE Context Setup Request message, the CU-CP 172A includes transport layer information for one or more GTP-U tunnels between the CU-UP 172B and DU 174 so that the DU 174 transmits the UL data and/or subsequent UL data (e.g., in small data communication 418) via the one or more GTP-U tunnels to the CU-UP 172B. In further implementations, in response, the DU 174 sends 410 a UE Context Setup Response message to the CU-CP 172A. After receiving 406 the first DU-to-CU message, transmitting 408 the (IE Context Setup Request message, and/or receiving 410 the (JE Context Setup Response message, the CU-CP 172A transmits 412 to the CU-UP 172B a Bearer Context Modification Request message to resume data transmission for the UE 102. In response, the CU-UP 172B resumes data transmission for the UE 102 and transmits 414 a Bearer Context Modification Response message to the CU-CP 172A. After receiving 408 the UJE Context Setup Request message and/or transmitting 410 the UJE Context Setup Response message, the DU 174 transmits 415 the DU-to-CU message including the UL data to the CU-CP 172A, such as in cases where the UL data packet (received at the event 404) includes an RRC message or is associated with an SRB (e.g., SRB1 or SRB2). In some cases where the UL data packet is associated with a DRB, the DU 174 transmits 416 the UL data packet to the CU-UP 172B via one of the one or more GTP-U tunnels.

In some implementations, the CU-CP 172A includes transport layer information of the CU-UP 172B in the UJE Context Setup Request message. In further implementations, the transport layer information of the CU-UP 172B includes an IP address and/or an uplink tunnel endpoint ID (e.g., TEID). Depending on the implementation, the DU 174 transmits 416 the UL data to the CU-UP 172B using the transport layer information of the CU-UP 172B. In some cases where the UF 102 has subsequent UI, data to transmit (e.g., one or more UL, data packets), the UE 102 transmits (at event 418) one or more subsequent UL MAC PDUs including the subsequent UL data to the DU 174. In some implementations, the UE 102 transmits the subsequent UL MAC PDU(s) to the DU 174 using the CG configuration and/or UL grant(s) (i.e., dynamical grant(s)). The DU 174 receives the subsequent UL MAC PDU(s) from the UE 102 in accordance with the CG configuration and/or UL grant(s). In turn, the DU 174 retrieves the subsequent UL data from the subsequent UL MAC PDU(s). In some implementations, the UE 102 receives (at event 418), from the DU 174, DCI(s), each including a particular UL grant of the UL grant(s). To transmit each of the DCI(s) to the UE 102, the DU 174 generates a CRC for the DCI, scrambles the CRC with an ID of the UE 102, and transmits the DCI and scrambled CRC on a PDCCH. In some implementations, the ID of the UE 102 is the C-RNTI or CS-RNTI. The UE 102 receives the DCI(s) and scrambles CRC(s) on the PDCCH(s) and transmits the subsequent UL MAC PDU(s) to the DU 174 in accordance with the DCI(s).

In some implementations, if the DU 174 fails to obtain a UL MAC PDU at event 418, the DU 174 commands the UE 102 to retransmit the UL MAC PDU. More specifically, the DU 174 generates a DCI including a UL grant (i.e., dynamic grant), generates a CRC for the DCI, scrambles the CRC with an ID of the UE 102, and transmits (at event 418) the DCI and scrambled CRC on a PDCCH to command the UE 102 to retransmit the UL MAC PDU. The UE 102 receives the DCI and scrambled CRC on the PDCCH from the DU 174 and retransmits the UL MAC PDU to the DU 174 in accordance with the UL grant or DCI. In some implementations, if the DU 174 still fails to obtain the UL MAC PDU, the DU 174 again commands the UE 102 to retransmit the UL MAC PDU in a similar manner as described above.

For each DCI and scrambled CRC that the UE 102 received at event 404 or 418, the UE 102 in some implementations verifies whether the CRC is valid using the ID of the UE 102 and the DCI. If the UE 102 verifies that the CRC is valid, the UE 102 transmits or retransmits the UL MAC PDU in accordance with the DCI. Otherwise if the UE 102 verifies that the CRC is not valid, the UE 102 discards the DCI.

In some implementations, the UE 102 includes a buffer status report or a power headroom report in the subsequent UL MAC PDU(s) (e.g., in accordance with the BSR configuration and/or PHR configuration, respectively). In some implementations, in the buffer status report, the UE 102 includes or indicates a buffer status of the UE 102 for one or more logical channels or logical channel groups In some implementations, in the power headroom report, the UE 102 includes or indicates power headroom status or value.

In cases where the subsequent UL data is associated with one or more SRB (e.g., SRB1 and/or SRB2), the DU 174 transmits 418 the one or more DU-to-CU messages, including the subsequent UL data, to the CU-CP 172A. Depending on the implementation, each DU-to-CU message includes a particular UL data packet of the subsequent UL data. In cases where the subsequent UL data is associated with one or more DRBs, the DU 174 transmits (at event 418) the subsequent UL data to the CU-UP 172B. In some implementations, the DU 174 includes transport layer information of the DU 174 in the UJE Context Setup Response message. In turn, in some implementations, the CU-CP 172A includes the transport layer information of the DU 174 in the Bearer Context Modification Request message. Depending on the implementation, the transport layer information of the DU 174 includes an IP address and/or a downlink TEID. In some cases where the CU-UP 172B receives DL data from the CN 110 or an edge server, the CU-UP 172B transmits 418 the DL data (e.g., one or more DL data packets) to the DU 174 using the transport layer information of the DU 174. In turn, the DU 174 transmits (at event 418) one or more DL MAC PDUs including the DL data to the UE 102 operating in the inactive state. In some implementations, the DU 174 transmits (at event 418) the DL MAC PDU(s) to the UE 102 using DL assignment(s). The UE 102 receives the DL MAC PDU(s) from the DU 174 in accordance with the DL assignment(s). In turn, the UE 102 retrieves the DL data from the DL MAC PDU(s). In some implementations, the UE 102 receives (at event 418), from the DU 174, DCI(s), each including a particular DL assignment of the DL assignment(s). To transmit each of the DCI(s) to the UE 102, the DU 174 generates a CRC for the DCI, scrambles the CRC with the ID of the UE 102 (e.g., the C-RNTI), and transmits the DCI and scrambled CRC on a PDCCH. The UE 102 receives the DCI(s) and scrambled CRC(s) on the PDCCH(s). The UE 102 receives DL transmission(s) from the DU 174 and obtains the DL MAC PDU(s) from the DL transmission(s).

In some implementations, if the UE 102 fails to obtain a DL MAC PDU at event 418, the UE 102 transmits a hybrid automatic repeat request (HARQ) negative acknowledgement (NACK) to the DU 174. More specifically, the DU 174 retransmits the DL MAC PDU as described below. In response to or after receiving the HARQ NACK, the DU 174 generates a DCI including a DL assignment, generates a CRC for the DCI, scrambles the CRC with an ID of the UE 102, and transmits the DCI and scrambled CRC on a PDCCH to indicate to the UE 102 to receive a retransmission of the DL MAC PDU. The UE 102 receives the DCI and scrambled CRC on the PDCCH from the DU 174 and verifies whether the CRC is valid using the ID of the UE 102 and the DCI. If the UE 102 verifies that the CRC is valid, the UE 102 attempts to receive or receives the retransmission of the DL MAC PDU in accordance with the DCI or DL assignment. Otherwise, if the UE 102 verifies that the CRC is not valid, the UE 102 discards the DCI. If the UE 102 successfully obtains the DL MAC PDU from the retransmission, the UE 102 transmits a HARQ acknowledgement (ACK) to the DU 174. Otherwise, the UE 102 transmits a HARQ NACK to the DU 174. The DU 174 then retransmits the DL MAC PDU in a similar manner as described above.

In some example scenarios, the UL data and/or DL data described above include Internet Protocol (IP) packet(s), Ethernet packet(s), or application packet(s). In other scenarios, the UL data includes PDU(s) (e.g., RRC PDU(s), PDCP PDU(s), or RLC PDU(s)) that include RRC message(s), NAS message(s), IP packet(s), Ethernet packet(s), or application packet(s).

The events 404, 406, 408, 410, 412, 414, 415, and 416 are collectively referred to in FIG. 4 as a small data transmission procedure 492.

In some implementations, the UL RRC message is an existing RRC resume request message (e.g, an RRC Resume Request message, an RRCResumeRequest1 message, an RRCConnectionResumeRequest message, or an RRCConnectionResumeRequest1 message). In other implementations, the UL RRC message is a new RRC resume request message, similar to the existing RRC resume request message. Depending on the implementation, the new RRC resume request message is a format of an existing RRC resume request message. In some implementations, in the case of the downlink SDT, the UL RRC message includes an SDT indication (e.g., a field or information element (IE) (e.g., resumeCause or ResumeCause)). In some implementations, the UL RRC message is a common control channel (CCCH) message.

In some implementations, after the UE 102 transmits 404 the UL MAC PDU or communicates 418 the subsequent UL data and/or DL data with the DU 174, the CU-CP 172A determines to stop the SDT for the UE 102 based on data inactivity of the UE 102 (i.e., the UE 102 in the inactive state has no data activity with the base station 104). For example, after the UE 102 transmits 404 the UL MAC PDU or communicates 418 the subsequent UL data and/or DL data with the DU 174, the UE 102 in the inactive determines or detects data inactivity and transmits 420, to the DU 174, UE assistance information (e.g., a UEAssistanceInformation message) indicating that the UE 102 prefers or requests to stop the SDT. In turn, the DU 174 transmits 421 a (I. RRC′ Message Transfer message, including the UE assistance information, to the CU-CP 172A. Thus, the CU-CP 172A can determine that the UE 102 is in a data inactivity state based on the UE assistance information. In other implementations, the DU 174 performs data inactivity monitoring for the UE 102. For example, the CU-CP 172A transmits a CU-to-DU message (e.g., the (JE Context Setup Request message of the event 408 or a UJE Context Modification Request message) to the DU 174 to request or command the DU 174 to perform the data inactivity monitoring. In some cases where the DU 174 detects or determines that the UF. 102 is in a data inactivity state during the monitoring, the DU 174 transmits 422 an inactivity notification (e.g., UE Inactivity Notification message) to the CU-CP 172A. Thus, the CU-CP 172A can determine that the UE 102 is in a data inactivity state based on the inactivity notification received from the DU 174. In yet other implementations, the CU-UP 172B performs data inactivity monitoring for the UE 102. For example, the CU-CP 172A transmits a CP-to-UP message to the CU-UP 172B to request or command the CU-UP 172B to perform the data inactivity monitoring. In some implementations, the CP-to-UP message is a Bearer Context Setup Request message or a Bearer Context Modification Request message before the UE 102 initiates the SDT. In other implementations, the CP-to-UP message is a Bearer Context Modification Request message during the SDT (e.g., the event 412). In cases where the CU-UP 172B detects or determines that the UE 102 is in a data inactivity state during the monitoring, the CU-UP 172B transmits 423 an inactivity notification (e.g., Bearer Context Inactivity Notification message) to the CU-CP 172A. Thus, the CU-CP 172A can determine that the UE 102 is in a data inactivity state based on the inactivity notification received from the CU-UP 172B. In some implementations, the CU-CP 172A determines that the UE 102 is in a data inactivity state based on any combination of the UE assistance information, inactivity notification of the event 422, and/or inactivity notification of the event 423.

In some implementations, after a certain period of data inactivity, the CU-CP 172A determines that neither the CU 172 nor the UE 102 has transmitted any data in the downlink direction or the uplink direction, respectively, during the certain period (e.g., using any of the techniques described above for the UE inactivity determination). In further implementations, in response to the determination, the CU-CP 172A determines to stop the SDT. Alternatively, the CU-CP 172A determines to immediately stop the SDT for the UE 102 in response to determining that the UE 102 is in a data inactivity state, irrespective of whether the CU 172 has transmitted data in the downlink direction in any particular time period.

In response to or after determining that the UE 102 is in a data inactivity state or otherwise determining to stop the SDT, the CU-CP 172A sends 424, to the CU-UP 172B, a Bearer Context Modification Request message to suspend data transmission for the UE 102. In response, the CU-UP 172B suspends data transmission for the UE 102 and sends 426 a Bearer Context Modification Response message to the CU-CP 172A. In response to or after determining that the UE 102 is in a data inactivity state or otherwise determining to stop SDT, the CU-CP 172A sends 428 a second CU-to-DU message (e.g., a LIE Context Modification Request message) to instruct the DU 174 to provide (i.e., request from the DU 174) an SDT DU configuration for the UE 102. In some implementations, the CU-CP 172A includes an SDT request indication (e.g., a field or IE) to request an SDT DU configuration in the second CU-to-DU message. In response to the SDT request indication or the second CU-to-DU message, the DU 174 transmits 430 a second DU-to-CU message (e.g., (JE Context Modification Response message) including a second SDT DU configuration to the CU-CP 172A. Alternatively, the DU 174 does not include an SDT DU configuration in the second DU-to-CU message, and the DU 174 instead sends to the CU-CP 172A another DU-to-CU message (e.g., (JE Context Modification Required message) including the second SDT DU configuration, after receiving the second CU-to-DU message (event 428) and/or after transmitting the second DU-to-CU message (event 430). In some alternative implementations, the CU-CP 172A transmits the second CU-to-DU message and receives the second DU-to-CU message (or receives the alternative DU-to-CU message discussed above) before determining that the UE 102 is in a data inactivity state.

In some implementations, the DU 174 includes a non-SDT DU configuration in the second DU-to-CU message. In such implementations, the CU-CP 172A generates an RRC resume message, including the non-SDT DU configuration, and sends 438 to the DU 174 an additional CU-to-DU including the RRC resume message. In turn, the DU 174 transmits 440 the RRC resume message to the UE 102. In response, the UE 102 transitions 441 to a connected state and transmits 442 an RRC resume complete message to the DU 174. The DU 174 then transmits 444 an additional DU-to-CU message (e.g., (II. RRC Message Transfer message) including the RRC resume complete message to the CU-CP 172A. In some implementations, the DU 174 includes the second SDT DU configuration in an IE (e.g., DU to CU RRC Information IE) of the second DU-to-CU message. In some such implementations, the DU 174 includes a non-SDT DU configuration according to a format of the IE, so that the DU 174 includes the third non-SDT DU configuration in the IE.

In some implementations, the third non-SDT DU configuration augments the first and/or second non-SDT DU configurations or includes at least one new configuration parameter not included in the first and/or second non-SDT DU configurations. In some such cases, the UE 102 in the connected state and the DU 174 communicate with one another using the third non-SDU DU configuration and the configuration parameters in the first and/or second non-SDT DU configurations that the third non-SDU DU configuration did not augment. In some implementations, the third non-SDT DU configuration includes configuration parameter(s) included in the first and/or second non-SDT DU configurations, and the DU 174 sets the configuration parameter(s) to the same value(s) in the first and/or second non-SDT DU configurations.

In other implementations, the DU 174 includes an indication to ignore or discard the third non-SDT DU configuration in the second DU-to-CU message of event 430. In response to the indication, the CU 172 discards the third non-SDT DU configuration. Thus, the events 438, 440, 441, 442, and 444 are omitted. For example, the indication is a non-SDT configuration ignorance indication or a cell group configuration (CellGroupConfig) ignorance indication.

In yet other implementations, the DU 174 generates the third non-SDT DU configuration as a special non-SDT DU configuration. For example, the special SDT DU configuration is an empty non-SDT DU configuration that neither (i) includes configuration parameters to augment the first and/or second non-SDT DU configurations, nor (ii) includes a new configuration parameter not included in the first and/or second non-SDT DU configurations. In some such examples, the special non-SDT DU configuration includes a cell group ID and/or empty IE(s) and/or configuration parameter(s) that have been configured for the UE 102 or transmitted to the UF 102. The empty IF(s) includes no configuration parameters. In another example, the special non-SDT DU configuration is a zero-length non-SDT DU configuration. In some implementations, the CU 172 determines to transmit the special non-SDT DU configuration to the UE 102 via the DU 174 at the events 438 and 440. In other implementations, the CU 172 determines to ignore or discard the special non-SDT DU configuration. Thus, the events 438, 440, 441, 442, and 444 are omitted.

In some implementations, the DU 174 determines to use at least one configuration parameter for the UE 102 to perform SDT and the at least one configuration parameter is not supported by the second SDT DU configuration. In such cases, the DU 174 includes the at least one configuration parameter in the third non-SDT DU configuration. For example, the at least configuration parameter includes RLC bearer configuration parameter(s), logical channel configuration parameter(s), MAC configuration parameter(s), and/or PHY configuration parameter(s). In some implementations, the DU 174 refrains from including MAC configuration parameter(s) and/or PHY configuration parameter(s) in the third non-SDT DU configuration.

In some implementations, the third non-SDT DU configuration includes configuration parameters in a CellGroupConfig 1E (e.g., as defined in 3GPP specification 38.331 v17.0.0). In some implementations, the third non-SDT DU configuration is a CellGroupConfig 1E including the configuration parameters. In some implementations, the RLC bearer configuration parameter(s) are RIC-Bearer Config 1E(s) or include configuration parameter(s) in the RIC-BearerConfig 1E. In some implementations, the logical channel configuration parameter(s) are LogicalChannelConfig 1E(s) or include configuration parameter(s) (e.g., logical ChannelGroup, logicalChannelSR-Delay TimerApplied, and logicalChanneISR-Mask) in the LogicalChannelConfig 1E. In some implementations, the MAC configuration parameter(s) are MAC-CellGroupConfig 1E(s) or include configuration parameter(s) (e.g., enhancedSkipUplinkTxDynamic, SkipUplinkTxDynamic, enhancedSkipUplinkTxConfigured, buffer status reporting (BSR) configuration and/or a power headroom reporting (PHR) configuration) in the MAC-CellGroupConfig 1E. In some implementations, the PHY configuration parameters are PhysicalCellGroupConfig 1E(s) or include configuration parameter(s) (e.g., a configured scheduling RNTI (CS-RNTI)) in the PhysicalCellGroupConfig 1E.

In some implementations, the DU 174 refrains from including a non-SDT DU configuration (e.g., CellGroupConfig 1E) in the second DU-to-CU message. In some implementations, the DU 174 includes the first SDT DU configuration in an existing or new IE of the second DU-to-CU message instead of the IE (e.g., the DU to CU RRC Information IE) of the second DU-to-CU message. A format of the existing or new IE does not include a non-SDT DU configuration (e.g., CellGroupConfig 1E), so that the DU 174 does not include a non-SDT DU configuration (e.g., CellGroupConfig 1E) in the second DU-to-CU message. In other implementations, the DU 174 artificially excludes a non-SDT DU configuration (e.g., CellGroupConfig 1E) from the IE (e.g., the DU to (‘U RRC’ Information IE) of the second DU-to-CU message when the DU 174 determines not to augment the first and/or second non-SDT DU configurations or not send a new non-SDT configuration parameter to the UE 102.

In some implementations, in response to determining to stop the SDT, the CU-CP 172A generates an RRC release message (e.g., RRCRelease message or RRCConnectionRelease message) to stop the SDT and cause the UE 102 to remain in the inactive state. In some implementations, the CU-CP 172A includes the SDT DU configuration and an SDT CU configuration in the RRC release message. The CU-CP 172A then sends 432 to the DU 174 a third CU-to-DU message (e.g., a UJE Context Release Command message or a UE Context Modification Request message) that includes the RRC release message. In turn, the DU 174 transmits 434 the RRC release message to the UE 102. The UE 102 stops the SDT (i.e., determines that the SDT session or procedure ends or terminated) and remains in the inactive state upon receiving the RRC release message. In some implementations, in response to or after stopping the SDT, the UE 102 stops the SDT session timer, stops monitoring a PDCCH for SDT, and/or releases a C-RNTI that the UE 102 uses to monitor a PDCCH for SDT. Alternatively, the UE 102 retains the C-RNTI. In further implementations, in response to the third CU-to-DU message, the DU 174 retains the SDT DU configuration and releases or does not release the first non-SDT DU configuration and/or second non-SDT DU configuration, as discussed above in connection with FIG. 3. The DU 174, depending on the implementation, sends a third DU-to-CU message (e.g., a UE Context Release Complete message or a UJE Context Modification Response message) to the CU-CP 172A in response to the third CU-to-DU message. In some implementations, if the RRC release message instructs the UE 102 to transition to an idle state (i.e., RRC_IDLE), the UE 102 transitions to the RRC_IDLE and releases a non-SDT configuration (e.g., the first non-SDT DU configuration, first non-SDT CU configuration, second non-SDT DU configuration, and/or second non-SDT CU configuration described for FIG. 3) and at least one SDT configuration (e.g., the first SDT DU configuration and/or first SDT CU configuration described for FIG. 3).

The events 420, 421, 422, 423, 424, 426, 428, 430, 438, 440, 442, 444, 432, 434 and 436 are collectively referred to in FIG. 4 as an SDT complete procedure 494 similar to the procedure 394. Examples and implementations discussed above for events 320, 321, 322, 323, 324, 326, 328, 330, 338, 340, 342, 344, 332, 334 can apply to events 420, 421, 422, 423, 424, 426, 428, 430, 438, 440, 442, 444, 432, 434, respectively. In some implementations, after stopping the SDT, the UE 102 performs another small data transmission procedure with the base station 104 or base station 106, similar to the procedure 494.

In some implementations, the CU-CP 172A does not request the DU 174 to provide an SDT DU configuration to stop SDT and cause the UE 102 to transition to the inactive state with SDT configured (e.g., RA-SDT). In some such cases, the events 428 and 430 are omitted. In such cases, the CU-CP 172A does not include an SDT DU configuration in the RRC release message. Alternatively, the CU-CP 172A generates the second SDT DU configuration by itself and includes the second SDT DU configuration in the RRC release message.

In some implementations, the DU 174 does not include an SDT DU configuration in the second DU-to-CU message (e.g., if or because the UE 102 does not support CG-SDT, the DU 174 does not support CG-SDT, or the DU 174 does not have available radio resources for CG-SDT). In some such cases, the RRC release message does not include an SDT DU configuration. Otherwise, the DU 174 includes the second SDT DU configuration as described above. In some implementations, the DU 174 does not include a CG-SDT configuration in the second SDT DU configuration in the second DU-to-CU message (e.g., if or because the UE 102 does not support CG-SDT, the DU 174 does not support CG-SDT, or the DU 174 does not have available radio resources for CG-SDT). In some such cases, the second SDT DU configuration does not include a CG-SDT configuration. Otherwise, the DU 174 includes the at least one CG-SDT configuration in the second SDT DU configuration as described above.

In some implementations, the CU-CP 172A requests the DU 174 to provide an SDT DU configuration as described above, such as in cases where the UE 102 supports CG-SDT and/or the DU 174 supports CG-SDT. In cases where the UE 102 does not support CG-SDT or the DU 174 does not support CG-SDT, the CU-CP 172A does not request the DU 174 to provide an SDT DU configuration. In some implementations, the CU-CP 172A receives a UE capability (e.g., UE-NR-Capability IE) of the UE 102 from the UE 102, the CN 110 (e.g., MME 114 or AMF 164), or the base station 106 before the UE 102 initiates the SDT, while the UE 102 operates 402 in the inactive state, while the UE 102 performs the SDT (e.g., in the UJE Context Setup Request message of the event 408 or the CU-to-DU message of the event 428), or while the UE 102 operates in the connected state, as described for FIG. 3. The UE capability indicates whether the UE 102 supports CG-SDT. Thus, the CU-CP 172A can determine whether the UE 102 supports CG-SDT in accordance with the UE capability. In some implementations, the CU-CP 172A receives, from the DU 174, a DU-to-CU message indicating whether the DU 174 supports CG-SDT. Depending on the implementation, the DU-to-CU message is the second DU-to-CU message, the message of the event 308 or 316, or a non-UE associated message (e.g., a non-UE associated F1AP message (e.g., as defined in 3GPP specification 38.473)).

In some implementations, the DU 174 determines whether to provide an SDT DU configuration for the UE 102 to the CU-CP 172A, based on whether the UE 102 supports CG-SDT or not. In further implementations, in addition to whether the UE 102 supports CG-SDT or not, the DU 174 additionally determines whether to provide an SDT DU configuration for the UE 102 to the CU-CP 172A based on whether the DU 174 supports CG-SDT or not. In cases where the UE 102 supports CG-SDT and/or the DU 174 supports or enables CG-SDT, the DU 174 provides the second SDT DU configuration for the UE 102 to the CU-CP 172A as described above. In cases where the UE 102 does not support CG-SDT or the DU 174 does not support CG-SDT, the DU 174 does not provide an SDT DU configuration for the UE 102 (e.g., the DU 174 does not include the second SDT DU configuration in the second DU-to-CU message). In some implementations, the DU 174 receives the UE capability from the CU-CP 172A, e.g., while the UE 102 operates in the connected state or in the inactive state. Thus, the DU 174 can determine whether the UE 102 supports CG-SDT in accordance with the UE capability. In some implementations, the DU 174 sends a DU-to-CU message to the CU-CP 172A to indicate whether the DU 174 supports CG-SDT, as described above.

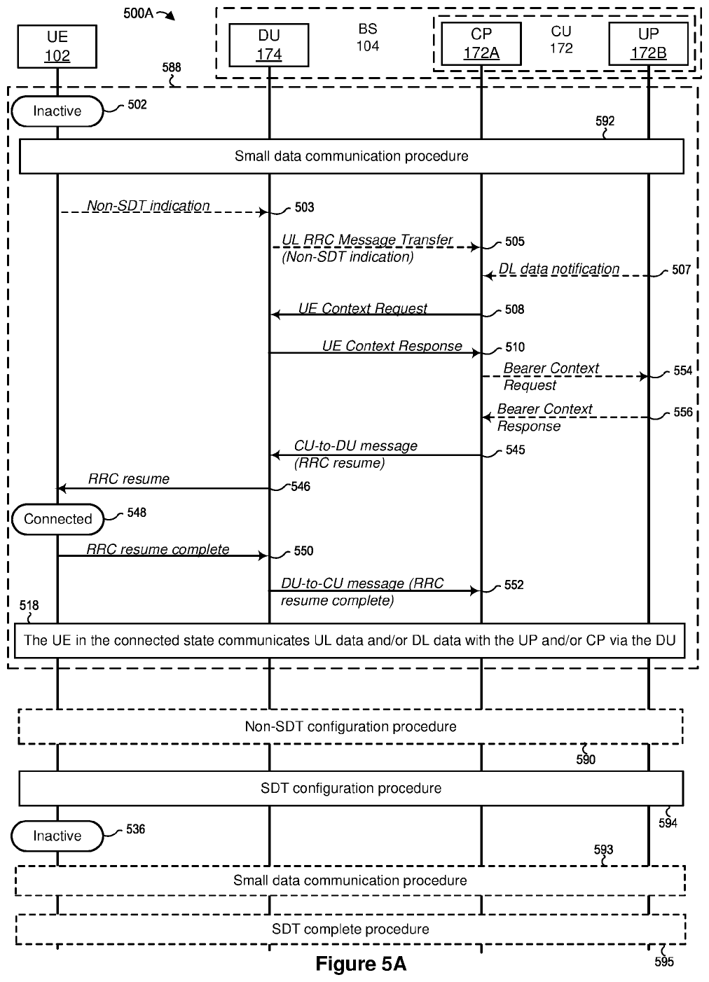

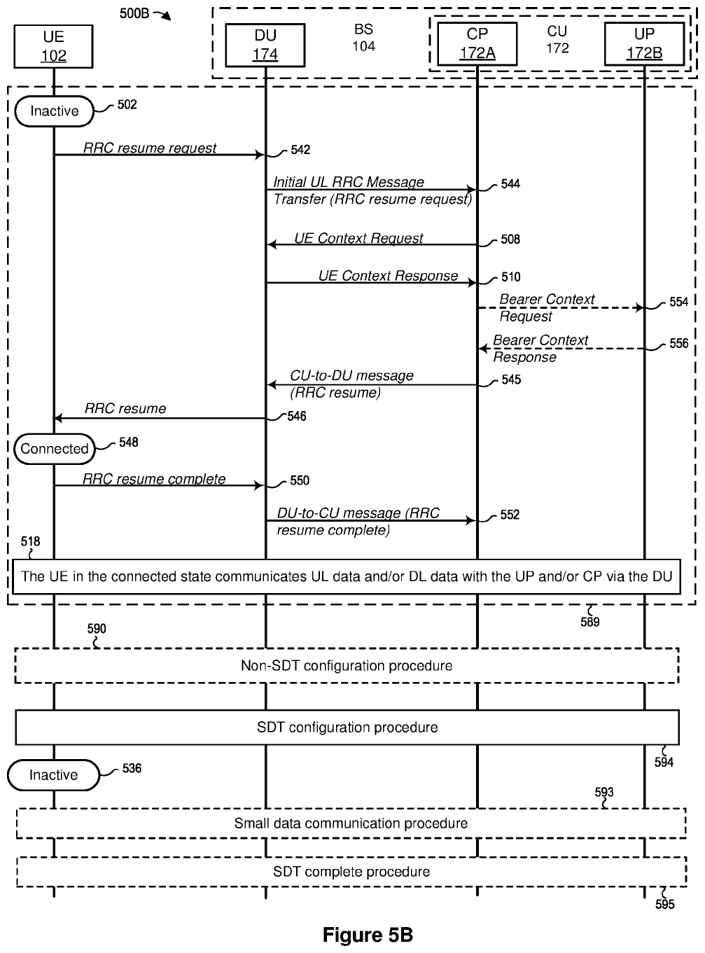

Referring now to FIG. 5A, a scenario 500A depicts SDT and transitioning from SDT to non-SDT. In the scenario 500A, the base station 104 includes a CU 172 and a DU 174. The CU 172 includes a CU-CP 172A and a CU-UP 172B. In the scenario 500A, the UE 102 initially operates 502 in an inactive state with SDT configured, similar to the event 402. The UE 102 then performs 592 an SDT procedure with the base station 104, similar to the event 492.

In some implementations, during the small data communication procedure 592, the CU-CP 172A determines whether to cause the UE 102 to transition to a connected state (e.g., based on UL or DL data activity of the UE 102). In some implementations, the UE 102 transmits 503, to the DU 174, a non-SDT indication message to indicate that UL data is available and/or request to transition to the connected state. In some implementations, the UE 102 transmits 503, to the DU 174, the non-SDT indication message on radio resources configured in a CG configuration for SDT (or CG-SDT configuration). In other implementations, the UE 102 receives a UL grant on a PDCCH from the DU 174 using a C-RNTI and transmits 503, to the DU 174, the non-SDT indication message on radio resources configured in the UL grant. In turn, the DU 174 transmits 505 a (IL RRC Message Transfer message including the non-SDT indication message to the CU-CP 172A. In some implementations, the CU-CP 172A determines to cause the UE 102 to transition to the connected state based on (e.g., in response to) the non-SDT indication message. In other implementations, the CU-UP 172B receives DL data from the CN 110 and, in response, transmits 507 a DL data notification (e.g., DI. Data Notification message) to the CU-CP 172A to indicate that DL data is available for transmission. In further implementations, the CU-CP 172A determines to cause the UE 102 to transition to the connected state based on the DL data notification. In yet other implementations and/or scenarios, the CU-CP 172A determines to cause the UE 102 to transition to the connected state based on measurement results received from the UE 102. In yet other implementations and/or scenarios, the CU-CP 172A receives DL data (e.g., NAS message(s)) from the CN 110 and determines to cause the UE 102 to transition to the connected state in response to receiving the DL data.

In some implementations, the UL data and/or DL data are associated with radio bearer(s) (e.g., SRB(s) and/or DRB(s)) of the UE 102. For example, the UL data includes RRC message(s) or NAS message(s) associated to SRB(s) of the UE 102. In another example, the UL data includes IP packet(s) associated with DRB(s) of the UE 102. In some implementations, the DRB(s) are SDT DRB(s). In other implementations, the DRB(s) are non-SDT DRB(s). In some implementations, the UE 102 includes ID(s) of the radio bearer(s) in the non-SDT indication message of event 503. Thus, the CU-CP 172A can determine whether to cause the UE 102 to transition to the connected state based on the ID(s). For example, if the radio bearer(s) identified by the ID(s) do not qualify for SDT, the CU-CP 172A determines to cause the UE 102 to transition to the connected state. Otherwise, the CU-CP 172A determines not to cause the UE 102 to transition to the connected state. In some implementations, the UE 102 includes data volume information of the UL data in the non-SDT indication message. Thus, the CU-CP 172A can determine whether to cause the UE 102 to transition to the connected state based on the data volume information. In some implementations, the data volume information includes a total data volume of the UL data. For example, in some implementations, the UE 102 quantizes or rounds the total data volume to a value that the UF. 102 includes in the data volume information. In another implementation, the data volume information includes a data volume for each of the radio bearer(s). For example, in further implementations, the UE 102 quantizes or rounds the data volume for each of the radio bearer(s) to a value that the UE 102 includes in the data volume information. In some implementations and/or scenarios, if the total data volume is above a predetermined threshold, the CU-CP 172A determines to cause the UE 102 to transition to the connected state. Otherwise, in further implementations, the CU-CP 172A determines not to cause the UE 102 to transition to the connected state. In another example, if the data volume for a particular radio bearer is above a predetermined threshold, the CU-CP 172A determines to cause the UE 102 to transition to the connected state. Otherwise, in further examples, the CU-CP 172A determines not to cause the UE 102 to transition to the connected state. In yet another example, if the total data volume is above a predetermined threshold and the data volume for a particular radio bearer is above another predetermined threshold, the CU-CP 172A determines to cause the UE 102 to transition to the connected state. Otherwise, in further examples, the CU-CP 172A determines not to cause the UE 102 to transition to the connected state.

After (e.g., in response to) determining to cause the UE 102 to transition to the connected state, the CU-CP 172A transmits 508 a UE Context Request message (e.g., a UE Context Setup Request message or a UE Context Modification Request message) to the DU 174. In response, the DU 174 transmits 510 a UE Context Response message (e.g., a UJE Context Setup Response message or a UE Context Modification Response message) to the CU-CP 172A. In some implementations, the DU 174 includes a non-SDT DU configuration (i.e., a first non-SDT DU configuration) in the UE Context Response message. After receiving 510 the UE Context Response message, the CU-CP 172A transmits 545 a CU-to-DU message including an RRC resume message (e.g., an RRCResume message or an RRCConnectionResume message) to the DU 174. In turn, the DU 174 transmits 546 the RRC resume message to the UE 102. In some implementations, the DU 174 transmits 546 one or more PDUs including the RRC resume message to the UE 102. Depending on the implementation, the PDU(s) are MAC PDU(s) or RLC PDU(s). In some implementations, the CU-to-DU message is a DL RRC Message Transfer message or a UE Context Modification Request message. In further implementations, in the case of the UE Context Modification Request message, the DU 174 transmits a UE Context Modification Response message to the CU-CP 172A in response. In response to the RRC resume message, the UE 102 transitions 548 to the connected state and transmits 550 an RRC resume complete message (e.g., an RRCResumeComplete message or an RRCConnectionResumeComplete message) to the DU 174. In cases where the UE Context Response message includes the non-SDT DU configuration, the CU-CP 172A includes the non-SDT DU configuration in the RRC resume message. The DU 174 transmits 552 a DU-to-CU message including the RRC resume complete message to the CU-CP 172A. In some implementations, the DU-to-CU message is a UL RRC Message Transfer message, a UE Context Modification Required message, or a UE Context Modification Response message.

In some implementations, the UE 102 stops the SDT (e.g., determines that the SDT session or procedure ends or is terminated) in response to receiving the RRC resume message or transitioning to the connected state. In some implementations, the UE 102 stops the SDT session timer in response to receiving the RRC resume message or transitioning to the connected state. In cases where the UE 102 is configured with the CG-SDT configuration as described above, the UE 102 stops using the CG-SDT configuration to transmit UL data in response to receiving the RRC resume message or transitioning to the connected state. In response to stopping using the CG-SDT configuration, the UE 102 (e.g., PHY 202B or MAC 204B) clears any configured grant configured in the CG-SDT configuration. In cases where the UE 102 is configured with a CS-RNTI for CG-SDT as described above, the UE 102 (e.g., PHY 202B) stops using the CS-RNTI to monitor a PDCCH in response to receiving the RRC resume message or transitioning to the connected state. In some implementations, the UE 102 retains a C-RNTI in response to transitioning to the connected state or receiving the RRC resume message. The UE 102 in the connected state uses the C-RNTI to communicate with the DU 174. In some implementations, the UE 102 uses the C-RNTI in the small data communication 592, similar to the procedure 492. The UE 102 receives the C-RNTI as described for FIGS. 3 and 4.

In some implementations, after determining to cause the UE 102 to transition to the connected state, the CU-CP 172A transmits a 554 Bearer Context Request message (e.g., a Bearer Context Setup Request message or a Bearer Context Modification Request message) to the CU-UP 172B to indicate that the CU-UP 172B is to resume radio bearer(s) (e.g., SDT DRB(s) and/or non-SDT DRB(s)) of the UE 102, if suspended. In response, the CU-UP 172B resumes the radio bearer(s) for the UE 102 and transmits 556 a Bearer Context Response message (e.g., a Bearer Context Setup Response message or a Bearer Context Modification Response message) to the CU CP-172A. The events 554 and 556 can be grouped as a Bearer Context procedure (e.g., a Bearer Context Setup procedure or a Bearer Context Modification procedure).

In some implementations, the CU-CP 172A transmits 554 the Bearer Context Request message after transmitting 508 the UE Context Request message, after receiving 510 the UE Context Response message, after transmitting 545 the CU-to-DU message, and/or after receiving 552 the DU-to-CU message. In cases where the CU-CP 172A determines no radio bearer(s) of the UE 102 are suspended when determining to cause the UE 102 to transition to the connected state, the CU-CP 172A does not transmit the Bearer Context Request message 554 to the CU-UP 172B. In some implementations, the CU-CP 172A transmits 545 the CU-to-DU message before or after transmitting 554 the Bearer Context Request message or receiving 556 the Bearer Context Response message.

In some implementations, the CU-CP 172A includes an indication to the DU 174 to generate a non-SDT configuration in the UE Context Request message of event 508, and the DU 174 includes the first non-SDT DU configuration in the UE Context Response message of event 510 in response to the indication. In yet other implementations, the CU-CP 172A stores a non-SDT DU configuration (i.e., a second non-SDT DU configuration) that a DU (e.g., the DU 174 or another DU or base station) used to communicate with the UE 102. In some such implementations, the UE 102 also stores the second non-SDT DU configuration. In some such cases, the CU-CP 172A includes the second non-SDT DU configuration in the UE Context Request message, and the DU 174 includes the first non-SDT DU configuration in the UE Context Response message in response to receiving the second non-SDT DU configuration. In some implementations, the first non-SDT DU configuration augments or replaces the second non-SDT DU configuration. Some examples and implementations for the first and second non-SDT DU configurations include any of the example non-SDT DU configurations described above. In some implementations, the DU 174 transmits an additional DU-to-CU message (e.g., a UE Context Modification Required message), including the first non-SDT DU configuration, to the CU-CP 172A instead of including the first non-SDT DU configuration in the UE Context Response message of event 510.

After transitioning 548 to the connected state, the UE 102 communicates 518 UL data and/or DL data with the CU-CP 172A and/or CU-UP 172B via the DU 174. More specifically, in some implementations, the UE 102 transmits 518 UL MAC PDU(s) including UL data to the DU 174 using UL grant(s) (i.e., dynamical grant(s)). The DU 174 receives 518 UL MAC PDU(s) from the UE 102 in accordance with the UL grant(s). In turn, the DU 174 retrieves the UL data from the UL MAC PDU(s). In some implementations, the UE 102 receives (at event 518) from the DU 174 DCI(s), each including a particular UL grant of the UL grant(s). To transmit each of the DCI(s) to the UE 102, the DU 174 generates a CRC for the DCI, scrambles the CRC with the ID of the UE 102 (i.e., the C-RNTI), and transmits the DCI and scrambled CRC on a PDCCH. The UE 102 receives the DCI(s) and scrambled CRC(s) on the PDCCH(s) and transmits the UL MAC PDU(s) to the DU 174 in accordance with the DCI(s), similar to the event 418.

In cases where the DU 174 receives DL data from the CU-CP 172A or CU-UP 172B, the DU 174 transmits (at event 518) one or more DL MAC PDUs, including the DL data, to the UE 102 operating in the connected state. In some implementations, the DU 174 transmits (at event 518) the DL MAC PDU(s) to the UE 102 using DL assignment(s). The UE 102 receives the DL MAC PDU(s) from the DU 174 in accordance with the DL assignment(s). In turn, the UE 102 retrieves the DL data from the DL MAC PDU(s). In some implementations, the UE 102 receives (at event 518), from the DU 174, DCI(s), each including a particular DL assignment of the DL assignment(s). To transmit each of the DCI(s) to the UE 102, the DU 174 generates a CRC for the DCI, scrambles the CRC with the ID of the UE 102 (e.g., the C-RNTI), and transmits the DCI and scrambled CRC on a PDCCH. The UE 102 receives the DCI(s) and scrambled CRC(s) on the PDCCH(s). The UE 102 receives DL transmission(s) from the DU 174 and obtains the DL MAC PDU(s) from the DL transmission(s).

In some implementations, the DU 174 uses different PDCCH configuration(s) for the PDCCH(s) at event 518 than PDCCH configuration(s) for the PDCCH(s) at event 418. In other implementations, the DU 174 uses the same PDCCH configuration(s) for the PDCCH(s) at event 518 as PDCCH configuration(s) for the PDCCH(s) at event 404 or 418. The PDCCH configuration(s) include a Control Resource Set (CORESET) configuration and/or a search space configuration. In some implementations, the RRC resume message of event 546 includes the PDCCH configuration(s). In some implementations, the DU 174 includes the PDCCH configuration(s) in the UE Context Response message of event 510, and the CU-CP 172A includes the PDCCH configuration(s) in the RRC resume message. In other implementations, the UE 102 receives the PDCCH configuration(s) from the base station 104 before initiating the SDT.

In some implementations, the UL data includes the UL data that triggered the UE 102 to transmit the non-SDT indication message at event 504. In further implementations, the UL data also includes new UL data available for transmission. In some implementations, the UL data is or includes PDCP PDU(s), RRC PDU(s), NAS PDU(s), or LTE positioning protocol (LPP) PDU(s). Depending on the implementation, the UL data is associated with an SRB (e.g., SRB1 or SRB2). In some implementations, the UE 102 applies one or more security functions (e.g., encryption and/or integrity protection) to the UL data as described above. The CU-CP 172A applies one or more security functions (e.g., decryption and/or integrity protection check) to the UL data as described above. In further implementations, the UL data is or includes PDCP PDU(s), SDAP PDU(s), IP packet(s), or Ethernet packet(s). In some implementations, the UL data is associated with DRB(s) (e.g., SDT DRB(s) and/or non-SDT DRB(s)). In some implementations, the UE 102 applies one or more security functions (e.g., encryption and/or integrity protection) to the UL data as described above. The CU-UP 172B applies one or more security functions (e.g., decryption and/or integrity protection check) to the UL data as described above.

In some implementations, the DL data includes the DL data that the CU 172 received from the CN 110 as described above. In further implementations, the DL data also includes new DL data that the CU-CP 172A and/or CU-UP 172B received from the CN 110. The DL data includes DL data packet(s) such as NAS PDU(s), LTE positioning protocol (LPP) PDU(s), IP packet(s), or Ethernet packet(s). For NAS PDU(s), the CU-CP 172A receives the NAS PDU(s) from the CN 110 (e.g., AMF 164) and generates RRC PDU(s) each including a particular NAS PDU of the NAS PDU(s). In the case of the LPP PDU(s), the CU-CP 172A receives the LPP PDU(s) from the CN 110 (e.g., location management function (LMF)) and generates RRC PDU(s), each including a particular LPP PDU of the LPP PDU(s). In some implementations, the CU-CP 172A applies one or more security functions (e.g., encryption and/or integrity protection) to the RRC PDU(s) as described above. The UE 102 applies one or more security functions (e.g., decryption and/or integrity protection check) to the RRC PDU(s) as described above. For IP packet(s) or Ethernet packet(s), the CU-UP 172B receives the DL data packet(s) from the CN 110 (e.g., UPF 162) or an edge server and generates PDCP PDU(s) each including a particular DL data packet of the DL data packet(s). In some implementations, the CU-UP 172B applies one or more security functions (e.g., encryption and/or integrity protection) to the DL data packet(s) as described above. The UE 102 applies one or more security functions (e.g., decryption and/or integrity protection check) to the DL data packet(s) as described above.

In cases where the RRC resume message of events 545 and/or 546 includes the first non-SDT DU configuration, the UE 102 communicates 518 with the DU 174 using the first non-SDT DU configuration. In some cases where the second non-SDT DU configuration is not completely replaced by the first non-SDT DU configuration (i.e., the UE 102 does not release the second non-SDT DU configuration in response to the RRC resume message), the UE 102 communicates 518 with the DU 174 using the configuration parameters in the second non-SDT DU configuration that are not augmented/replaced by the first non-SDT DU configuration.

In some implementations, the DU 174 does not provide the first non-SDT DU configuration to the CU-CP 172A in the UE Context Response message and the additional DU-to-CU message. In such cases, the RRC resume message of events 545 and/or 546 does not include the first non-SDT configuration, and the UF 102 and the DU 174 communicate 518 with one another using the second non-SDT DU configuration.

In some implementations, the UE 102 releases the SDT configuration(s) (e.g., the SDT CU configuration, the SDT DU configuration, and/or the CG-SDT configuration(s) in response to receiving the RRC resume message or transitioning to the connected state. In some implementations, the base station 104 (e.g., the CU-CP 172A and/or DU 174) releases the SDT configuration(s) after (e.g., in response to) causing the UE 102 to transition to the connected state, after receiving 510 the CU-to-DU message, or after transmitting 545, 546 the RRC resume message. In other implementations, the base station 104 releases the SDT configuration(s) in response to or after receiving an acknowledgement (e.g., a RLC acknowledgement or a HARQ acknowledgement) for the PDU(s) including the RRC resume message. In yet other implementations, the base station 104 (e.g., the CU-CP 172A and/or DU 174) releases the SDT configuration(s) in response to or after communicating 508 the UE Context Request message or 510 the UE Context Response message.

In other implementations, the UE 102 retains the SDT configuration(s) (e.g., the SDT CU configuration, the SDT DU configuration, and/or the CG-SDT configuration(s)) in response to or after receiving the RRC resume message or transitioning to the connected state. In some implementations, the UE 102 refrains from using the SDT configuration(s) to communicate (e.g., communicate 550 the RRC resume complete message and/or 518 data) with the base station 104, while operating in the connected state. In other implementations, the UE 102 uses the SDT configuration(s) to communicate (e.g., communicate 550 the RRC resume complete message and/or 518 data) with the base station 104, while operating in the connected state. In some implementations, the base station 104 retains the SDT configuration(s) in response to or after causing the UE 102 to transition to the connected state or transmitting the RRC resume message. In some implementations, the base station 104 refrains from using the SDT configuration(s) to communicate (e.g., 550 the RRC resume complete message and/or 518 data) with the UE 102 operating in the connected state. In other implementations, the base station 104 uses the SDT configuration(s) to communicate (e.g., 550 the RRC resume complete message and/or 518 data) with the UE 102 operating in the connected state.

In some implementations, the UE 102 discards a UE Inactive AS Context in response to or after causing the UF 102 to transition to the connected state or transmitting the RRC resume message. In some implementations, the UE 102 releases one or more configuration parameters in a suspend configuration (e.g., SuspendConfig), except RAN notification area information (e.g., RAN-NotificationAreaInfo). In further implementations, the UE 102 receives the suspend configuration in an RRC release message from the base station 104, similar to event 334 or 434, before performing 592 the procedure.

In some implementations, the non-SDT indication message of event 503 is an RRC message (e.g., a (JEAssistanceInformation message or a new/dedicated RRC message). In some such cases, the UE 102 continues to perform small data communication with the base station 104 after transmitting the non-SDT indication message. In some implementations, the UE 102 transmits 503 a UL MAC PDU, including the non-SDT indication message, to the CU-CP 172A via the DU 174. In some implementations, the UE 102 includes data in the UL MAC PDU in addition to the non-SDT indication message. In other implementations, the UE refrains from including data in the UL MAC PDU. In some implementations, the UE 102 transmits the non-SDT indication message to the CU-CP 172A via the DU 174 and SRB1.

To transmit 503 the non-SDT indication message, the UE 102 generates a UL PDCP PDU including the non-SDT indication message, generates a UL RLC PDU including the UL PDCP PDU, generates a UL MAC PDU including the UL RLC PDU, and transmits 503 the UL MAC PDU to the DU 174 using the CG configuration and/or a UL grant (i.e., dynamical grant). The DU 174 receives the UL MAC PDU in accordance with the CG configuration and/or UL grant. In turn, the DU 174 retrieves the UL RLC PDU from the UL MAC PDU, retrieves the UL PDCP PDU from the UL RLC PDU, and transmits the UL PDCP PDU to the CU-CP 172A at event 505. The CU-CP 172A retrieves the non-SDT indication message from the UL PDCP PDU. In some implementations, the UE 102 receives, from the DU 174, a DCI including the UL grant. To transmit the DCI to the UE 102, the DU 174 generates a CRC for the DCI, scrambles the CRC with an ID (e.g., the C-RNTI or CS-RNTI) of the UE 102, and transmits the DCI and scrambled CRC on a PDCCH. In some implementations, if the DU 174 fails to obtain a UL MAC PDU at event 503, the DU 174 commands the UE 102 to retransmit the UL MAC PDU. More specifically, in some such implementations, the DU 174 generates a DCI including a UL grant (i.e., dynamic grant), generates a CRC for the DCI, scrambles the CRC with the ID of the UE 102, and transmits the DCI and scrambled CRC on a PDCCH to command the UE 102 to retransmit the UL MAC PDU. The UE 102 receives the DCI and scrambled CRC on the PDCCH from the DU 174 and retransmits the LI. MAC PDU to the DU 174 in accordance with the UL grant or DCI. In further implementations, if the DU 174 fails to obtain the UL MAC PDU from the retransmission of the UL MAC PDU, the DU 174 again commands the UE 102 to retransmit the UL MAC PDU in a similar manner as described above.

To transmit 545 the RRC resume message to the DU 174, the CU-CP 172A generates a DL PDCP PDU including the RRC resume message and includes the DL PDCP PDU in the CU-to-DU message of event 545. The DU 174 generates a DL RLC PDU including the DL PDCP PDU, generates a DL MAC PDU including the DL RLC PDU, and transmits 546 the DL MAC PDU to the UE 102 using a DL assignment. The UE 102 receives the DL MAC PDU in accordance with the DI assignment. In turn, the UF 102 retrieves the DI, RLC PDU from the DL MAC PDU, retrieves the DL PDCP PDU from the DL RLC PDU, and transmits the UL PDCP PDU to the CU-CP 172A. In some implementations, the UE 102 receives, from the DU 174, a DCI including the DL assignment. To transmit the DCI to the UE 102, the DU 174 generates a CRC for the DCI, scrambles the CRC with an ID of the UE 102 (e.g., the C-RNTI), and transmits the DCI and scrambled CRC on a PDCCH. In some implementations, if the UE 102 fails to obtain a DL MAC PDU at event 546, the UE 102 transmits a HARQ NACK to the DU 174. In further implementations, in response to or after receiving HARQ NACK, the DU 174 retransmits the DL MAC PDU to the UE 102. More specifically, the DU 174 generates a DCI including a DL assignment, generates a CRC for the DCI, scrambles the CRC with the ID of the UE 102, and transmits the DCI and scrambled CRC on a PDCCH to command the UE 102 to retransmit the DL MAC PDU. The UE 102 receives the DCI and scrambled CRC on the PDCCH from the DU 174 and receives the retransmission of the DL MAC PDU from the DU 174 in accordance with the DL assignment or DCI. If the UE 102 successfully obtains the DL MAC PDU from the retransmission of the DL MAC PDU, the UE 102 transmits a HARQ ACK to the DU 174. Otherwise, in some implementations, if the UE 102 fails to obtain the DL MAC PDU from the retransmission of the DL MAC PDU, the UE 102 transmits a HARQ ACK to the DU 174. The DU 174 then, in further implementations, retransmits the DL MAC PDU to the UE 102 in a similar manner as described above.

To transmit 550 the RRC resume complete message, the UE 102 generates a UL PDCP PDU including the RRC resume complete message, generates a UI, RIC PDU including the UI. PDCP PDU, generates a UL MAC PDU including the UL RLC PDU, and transmits 550 the UL MAC PDU to the DU 174 using a UL grant (i.e., dynamical grant). The DU 174 receives the UL MAC PDU in accordance with a UL grant. In turn, the DU 174 retrieves the UL RLC PDU from the UL MAC PDU, retrieves the UL PDCP PDU from the UL RLC PDU, and transmits the UL PDCP PDU to the CU-CP 172A at event 505. The CU-CP 172A retrieves the RRC resume complete message from the UL PDCP PDU. In some implementations, the UE 102 receives, from the DU 174, a DCI including the UL grant. To transmit the DCI to the UE 102, the DU 174 generates a CRC for the DCI, scrambles the CRC with an ID of the UE 102 (i.e., the C-RNTI), and transmits the DCI and scrambled CRC on a PDCCH. In some implementations, if the DU 174 fails to obtain a UL MAC PDU at event 503, the DU 174 commands the UE 102 to retransmit the UI, MAC PDU. More specifically, in further implementations, the DU 174 generates a DCI including a UL grant (i.e., dynamic grant), generates a CRC for the DCI, scrambles the CRC with an ID of the UE 102, and transmits the DCI and scrambled CRC on a PDCCH to command the UE 102 to retransmit the UL MAC PDU. The UE 102 receives the DCI and scrambled CRC on the PDCCH from the DU 174 and retransmits the UL MAC PDU to the DU 174 in accordance with the UL grant or DCI. In further implementations, if the DU 174 fails to obtain the UL MAC PDU from the retransmission of the UL MAC PDU, the DU 174 again commands the UE 102 to retransmit the UL MAC PDU in a similar manner as described above.

In other implementations, the non-SDT indication message is an RRC resume request message (e.g., RR (Resume Request message or RR (Resume ConnectionRequest message). In some such implementations, the UE 102 stops 592 small data communication with the base station 104 to transmit the non-SDT indication message. In some implementations, the UE 102 transmits the non-SDT indication message to the CU-CP 172A via the DU 174 and SRB0. In some implementations, the UE 102 re-establishes the UE PDCP entity in response to determining to transmit the non-SDT indication. After re-establishing the UE PDCP entity, the UE 102 receives 546 the DL PDCP PDU using the UE PDCP entity from the DU 174. Similarly, the CU-CP 172A re-establishes the CU-CP PDCP entity upon receiving the non-SDT indication message. After re-establishing the CU-CP PDCP entity, the CU-CP 172A generates the DL PDCP PDU using the CU-CP PDCP entity and transmits 545, 546 the DL PDCP PDU to the UE 102 via the DU 174 and SRB1. After re-establishing the UE PDCP entity, the UE 102 generates a UL PDCP PDU including the RRC resume complete message using the UF PDCP entity and transmits 550, 552 the UL PDCP PDU to the CU-CP 172A via the DU 174 and SRB1. After re-establishing the CU-CP PDCP entity, the CU-CP 172A receives 550, 552 the UL PDCP PDU from the UE 102 via the DU 174, using the CU-CP PDCP entity.

Before performing 592 the small data communication procedure, the UE 102 operating 502 in the inactive state starts or restarts a first UE CG-SDT timer (e.g., CG-SDT-TAT), as described for FIGS. 3 and 4. In some implementations, the UE 102 starts or restarts the first UE CG-SDT timer in response to receiving a timing advance command from the DU 174 during 592 the small data communication procedure. In some implementations, the UE 102 maintains (e.g., keeps or does not stop, start, or restart) the first UF CG-SDT timer (e.g., CG-SDT-TAT) running in response to or after receiving the RRC resume message. In other implementations, the UE 102 stops the first UE CG-SDT timer in response to or after receiving the RRC resume message.

Similarly, depending on the implementation, the DU 174 runs a first DU CG-SDT timer for the UE 102 operating 502 in the inactive state, as described for FIGS. 3 and 4. In some implementations, the DU 174 starts or restarts the first DU CG-SDT timer in response to transmitting a timing advance command to the UE 102. In some implementations, the DU 174 maintains (e.g., keeps or does not stop, start or restart) the first DU CG-SDT timer as running in response to or after receiving 508 the UE Context Request message, transmitting 510 the UE Context Response message, or transmitting 512 the resume message. In other implementations, the DU 174 stops the first DU CG-SDT timer in response to or after receiving 508 the UE Context Request message, transmitting 510 the UE Context Response message, or transmitting 545 the RRC resume message. In some cases where the first DU CG-SDT timer expires, the DU 174 releases the CG-SDT configuration(s). In other cases where the first DU CG-SDT timer expires, the DU 174 alternatively retains the CG-SDT configuration(s) and refrains from receiving or attempting to receive UL transmissions (e.g., MAC PDUs) on the CG resources. In some cases, the DU 174 releases the CG resources or determines the CG resources as not valid.

In some implementations, the UE 102 in the inactive state runs a second UE CG-SDT timer during 592 the small data communication procedure, as described for the procedure 492. In some cases where the second UE CG-SDT timer is running, the UE 102 stops the second UE CG-SDT timer in response to or after receiving 546 the RRC resume message or transitioning 548 to the connected state. Alternatively, the UE 102 maintains the second UE CG-SDT timer running in response to or after receiving 546 the RRC resume message or transitioning 548 to the connected state. In some implementations, the UE 102 receives an RRC setup message (e.g., RRCSetup message) instead of the RRC resume message. In response to or after receiving the RRC setup message, the UE 102 stops the second UE CG-SDT timer and transmits an RRC setup complete message to the CU-CP 172A via the DU 174.

Similarly, depending on the implementation, the DU 174 runs a second DU CG-SDT timer during 592 the small data communication procedure. In some implementations, the DU 174 starts or restarts the second DU CG-SDT timer when or after receiving from the UE 102 a PUSCH transmission on radio resources configured in the CG-SDT configuration. In some implementations, while the second DU CG-SDT timer is running, the DU 174 transmits a PDCCH using the C-RNTI. In cases where the second DU CG-SDT timer is running, the DU 174 stops the second DU CG-SDT timer in response to or after receiving 508 the UE Context Request message, transmitting 510 the UE Context Response message, or transmitting 546 the RRC resume message. In other implementations, the DU 174 maintains the second DU CG-SDT timer in response to or after receiving 508 the UE Context Request message, transmitting 510 the UE Context Response message, or transmitting 546 the RRC resume message. The DU 174 transmits, to the UE 102 operating in the connected state, a DCI and/or a PDCCH using the C-RNTI irrespective of the second DU CG-SDT timer (e.g., running, expiring, or stopping).

The events 502, 592, 503, 505, 507, 508, 510, 545, 546, 548, 550, 552, 554, 556, and 518 are collectively referred to in FIG. 5A as a state transition procedure 588.

Later in time, in some implementations, the base station 104 performs 590 a non-SDT configuration procedure and 594 an SDT configuration procedure with the UE 102, similar to the procedure 390 and the procedure 394, respectively. The UE 102 transitions 536 to the inactive state in response to receiving an RRC release message in the procedure 594. In some implementations, after transitioning to the inactive state, the UE 102 in the inactive state performs 593 a small data communication procedure and 595 an SDT complete procedure with the base station 104, similar to the procedure 492 and 494, respectively.

Referring next to FIG. 5B, a scenario 500B is generally similar to the scenario 500A, except that the UE 102 initiates an RRC resume procedure instead of initiating 592 the small data communication procedure. The differences between the scenarios 500B and 500A are discussed below.

In response to initiating the RRC resume procedure, the UE 102 in the inactive state transmits 542 an RRC resume request message to the DU 174, which in turn transmits 544 an Initial UL RRC Message Transfer message including the RRC resume request message (e.g., an RRC ResumeRequest message or an RRCConnectionResume Request message) to the CU-CP 172A. In response to receiving the RRC resume request message, the CU-CP 172A determines to cause the UE 102 to transition to the connected state. In response to or after determining to cause the UE 102 to transition to the connected state, the CU-CP 172A transitions the UE to the connected state as described for the scenario 500A.

In some implementations, the UE 102 generates a UL MAC PDU, including the RRC resume request message, and transmits 542 UL MAC PDU to the DU 174. In some implementations, the UE 102 transmits 542 to the DU 174 the UL MAC PDU on radio resources configured in a CG configuration for SDT. In other implementations, the UE 102 performs a random access procedure to transmit the UL MAC PDU, similar to the event 404.

In some implementations, the UE 102 initiates the RRC resume procedure to transmit non-SDT data (i.e., data not qualifying for SDT). More specifically, an upper protocol layer (e.g., NAS layer) of the UE 102 requests an RRC layer (e.g., RRC 214) of the UE 102 to initiate the RRC resume procedure. In other implementations, the UE 102 receives a paging message from the DU 174 and initiates the RRC resume procedure to respond the paging message. In some implementations, the RRC layer (e.g., RRC 214) initiates the RRC resume procedure in response to the paging message. In yet other implementations, the UE 102 detects a periodic RAN notification area update (RNAU) timer expires and initiates the RRC resume procedure in response to the periodic RNAU timer expiring. In some implementations, the RRC layer (e.g., RRC 214) starts or restarts the RNAU timer, maintains the RNAU timer running, and initiates the RRC resume procedure in response to the RNAU timer expiring.

The events 502, 542, 544, 508, 510, 545, 546, 548, 550, 552, 554, 556, and 518 are collectively referred to in FIG. 5B as a state transition procedure 589.

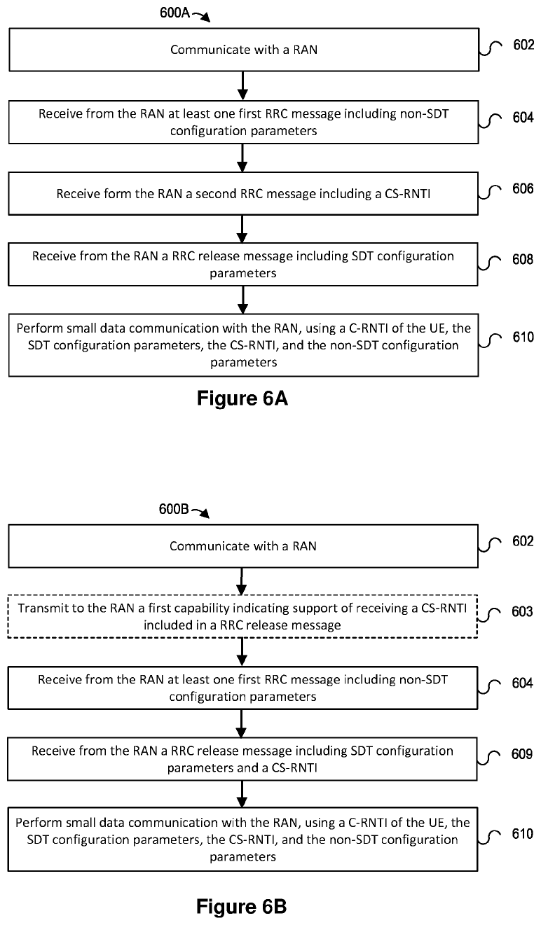

Next, several example methods that can be implemented in a UE; in one or more base stations, DUs or CUs; or in a RAN to support data communications in the inactive state are discussed next with reference to FIGS. 6A-16. Examples and implementations described for FIGS. 3, 4 and 5A-5B can apply to FIGS. 6A-16.

FIG. 6A illustrates a method 600A, implemented by a UE (e.g., the UE 102), for performing small data communication with a RAN (e.g., the RAN 105 or base station 104, 106).

The method 600A begins at block 602, where the UE communicates with the RAN (e.g., events 304, 306, 318, 310, 312, 316, 314, 318, 390, 320, 321, 322, 404, 406, 408, 410, 415, 416, 418, 494, 420, 421, 422, 503, 592, 546, 550, 518, 588, 590 of FIGS. 3-5B). At block 604, the UE receives from the RAN at least one first RRC message including non-SDT configuration parameters (e.g., events 312, 390, 340, 440, 546, 590 of FIGS. 3-5B). At block 606, the UE receives from the RAN a second RRC message including a CS-RNTI (e.g., e.g., events 312, 390, 340, 440, 546, 590 of FIGS. 3-5B). At block 608, the UE receives, from the RAN, an RRC release message including SDT configuration parameters (e.g., events 334, 434, 494, 594, 595 of FIGS. 3-5B). At block 610, the UE performs data communication with the RAN, using a C-RNTI of the UE, the SDT configuration parameters, the CS-RNTI, and the non-SDT configuration parameters (e.g., events 404, 418, 492, 420, 440, 434, 592, 546 of FIGS. 3-5B).

In some implementations, SDT configuration parameters include configuration parameters for SDT (e.g., CG-SDT and/or RA-SDT) as described above. In some implementations, the non-SDT configuration parameters include configuration parameters for non-SDT procedures as described above. In some implementations, the at least one first RRC message includes the second RRC message, RRC reconfiguration message(s), and/or RRC resume message(s). In some implementations, the second RRC message is an RRC reconfiguration message or an RRC resume message. In some implementations, the second RRC message does not include a CG configuration. In some implementations, the RRC release message does not include the CS-RNTI.

FIG. 6B is a flow diagram of an example method 600B similar to the method 600A, except that method 600B includes blocks 603 and 609 instead of blocks 606 and 608. At block 603, the UE transmits, to the RAN, a first capability indicating support for receiving a CS-RNTI included in an RRC release message. At block 609, the UE receives, from the RAN, an RRC release message including SDT configuration parameters and a CS-RNTI (e.g., events 334, 434, 494, 594, 595 of FIGS. 3-5B).

In some implementations, the RAN decides to include the CS-RNTI in the RRC release message in accordance with the first capability. If the UE does not transmit the first capability to the RAN, the RAN transmits a second RRC message, including the CS-RNTI, to the UE as described for block 606 of FIG. 6A.

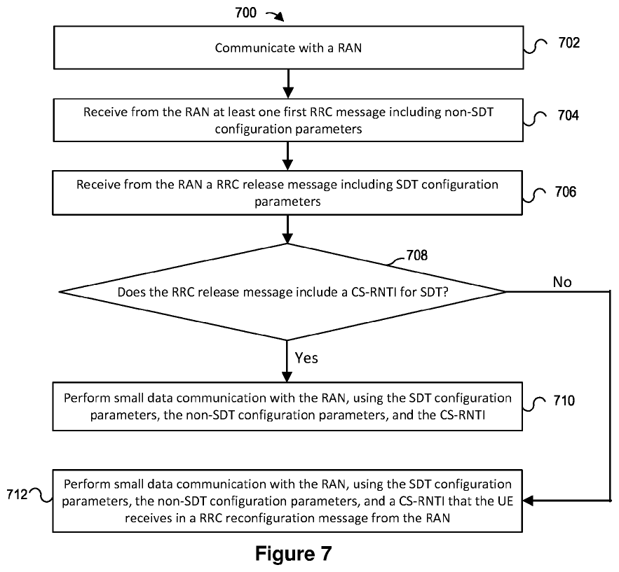

FIG. 7 illustrates a method 700, implemented by a UE (e.g., the UE 102), for performing small data communication with a RAN (e.g., the RAN 105 or base station 104, 106).

The method 700 begins at block 702, where the UE communicates with the RAN (e.g., events 304, 306, 318, 310, 312, 316, 314, 318, 390, 320, 321, 322, 404, 406, 408, 410, 415, 416, 418, 494, 420, 421, 422, 503, 592, 546, 550, 518, 588, 590 of FIGS. 3-5B). At block 704, the UE receives, from the RAN, at least one first RRC message including non-SDT configuration parameters (e.g., events 312, 390, 340, 440, 546, 590 of FIGS. 3-5B). At block 706, the UE receives, from the RAN, an RRC release message including SDT configuration parameters (e.g., events 334, 434, 494, 594, 595 of FIGS. 3-5B). At block 708, the UE determines whether the RRC release message includes a CS-RNTI for SDT. If the UE determines that the RRC release message includes a CS-RNTI for SDT, the flow proceeds to block 710. At block 710, the UE performs small data communication with the RAN using the SDT configuration parameters, the non-SDT configuration parameters, and the CS-RNTI (e.g., events 404, 418, 492, 420, 440, 434 of FIG. 4). If the UE determines that the RRC release message does not include a CS-RNTI for SDT, the flow proceeds to block 712. At block 712, the UE performs small data communication with the RAN using the SDT configuration parameters, the non-SDT configuration parameters, and a CS-RNTI that the UE receives in an RRC reconfiguration message from the RAN (e.g., events 312, 390, 340, 440, 546, 590, 404, 418, 492, 420, 440, 434 of FIGS. 3-5B).

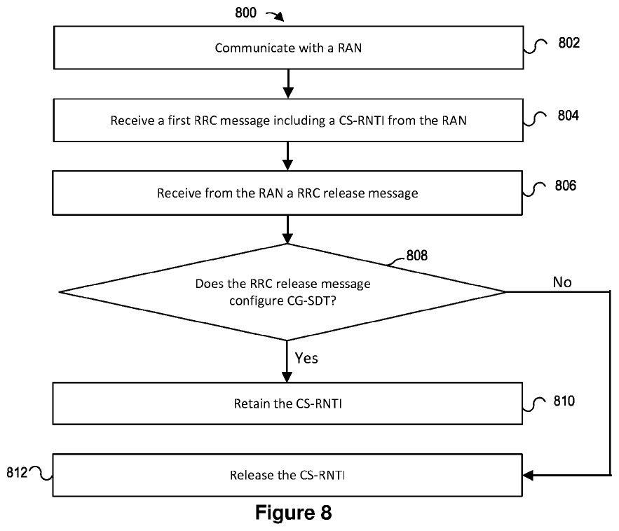

FIG. 8 illustrates a method 800, implemented by a UE (e.g., the UE 102), for performing small data communication with a RAN (e.g., the RAN 105 or base station 104, 106).

The method 800 begins at block 802, where the UE communicates with the RAN (e.g., events 304, 306, 318, 310, 312, 316, 314, 318, 390, 320, 321, 322, 404, 406, 408, 410, 415, 416, 418, 494, 420, 421, 422, 503, 592, 546, 550, 518, 588, 590 of FIGS. 3-5B). At block 804, the UE receives, from the RAN, a first RRC message including a CS-RNTI (e.g., events 312, 390, 340, 440, 546, 590 of FIGS. 3-5B). At block 806, the UE receives, from the RAN, an RRC release message (e.g., events 334, 434, 494, 594, 595 of FIGS. 3-5B). At block 808, the UE determines whether the RRC release message configures CG-SDT. If the UE determines that the RRC release message configures CG-SDT, the flow proceeds to block 810. At block 810, the UE retains the CS-RNTI. If the UE determines that the RRC release message does not configure CG-SDT, the flow proceeds to block 812. At block 812, the UE releases the CS-RNTI.

In some implementations, the first RRC message is an RRC reconfiguration message, and the UE transmits an RRC reconfiguration complete message to the RAN in response to the RRC reconfiguration message. In other implementations, the first RRC message is an RRC resume message, and the UE transmits an RRC resume complete message to the RAN in response to the RRC resume message.

In some implementations, the UE stores the CS-RNTI for CG-SDT in the UE Inactive AS Context when or in response to receiving the RRC release message. In some implementations, the UE restores the CS-RNTI when the UE initiates a CG-SDT procedure. In some implementations, the UE starts using the CS-RNTI to monitor a PDCCH using the CS-RNTI in response to or after initiating the CG-SDT procedure with the RAN. In some implementations, the UE starts using the CS-RNTI to monitor a PDCCH after transmitting an initial SDT transmission of the CG-SDT procedure (e.g., event 404 of FIG. 4). In some implementations, when the UE monitors a PDCCH using the CS-RNTI, the UE monitors a PDCCH addressed to the CS-RNTI. In some scenarios or implementations, when or while monitoring a PDCCH using the CS-RNTI, the UE receives a DCI and a CRC scrambled with the CS-RNTI on a PDCCH. The UE verifies whether the CRC is valid using the CS-RNTI. In some implementations, if the UE verifies that the CRC is valid and the DCI includes a UL grant, the UE transmits a UL transmission to the RAN using the UL grant. In some implementations, the UL transmission is a new transmission. In other implementations, the UL transmission is a retransmission. In some implementations, if the UE verifies that the CRC is valid and the DCI includes a DL assignment, the UE receives a DL transmission from the RAN using the DL assignment.

In some implementations, the UE stops using the CS-RNTI to monitor a PDCCH when or after the UE stops or completes the CG-SDT procedure (e.g., events 403, 434, 494, 594, 595 of FIGS. 4-5B). In some implementations, the UE stops the CG-SDT procedure in response to receiving an RRC resume message (e.g., event 546 of FIGS. 5A-5B), RRC setup message or transitioning to the connected state (e.g., event 548 of FIGS. 5A-5B). In other implementations, the UE stops the CG-SDT procedure in response to receiving an RRC reject message.

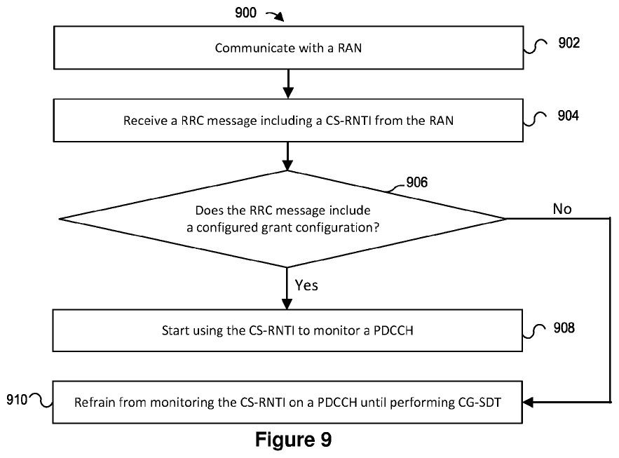

FIG. 9 illustrates a method 900, implemented by a UE (e.g., the UE 102), for performing small data communication with a RAN (e.g., the RAN 105 or base station 104, 106).

The method 900 begins at block 902, where the UE communicates with the RAN (e.g., events 304, 306, 318, 310, 312, 316, 314, 318, 390, 320, 321, 322, 404, 406, 408, 410, 415, 416, 418, 494, 420, 421, 422, 503, 592, 546, 550, 518, 588, 590 of FIGS. 3-5B). At block 904, the UE receives, from the RAN, an RRC message including a CS-RNTI (e.g., events 312, 390, 340, 344, 440, 546, 590 of FIGS. 3-5B). At block 906, the UE determines whether the RRC message includes a configured grant configuration. If the UE determines that the RRC message includes a configured grant configuration, the flow proceeds to block 908. At block 908, the UE starts using the CS-RNTI to monitor a PDCCH. If the UE determines that the RRC message does not include a configured grant configuration, the flow proceeds to block 910. At block 910, the UE refrains from monitoring the CS-RNTI on a PDCCH until performing CG-SDT.

In some implementations, the RRC message is an RRC reconfiguration message. In other implementations, the RRC message is an RRC resume message. The UE starts using the CS-RNTI to monitor a PDCCH in response to or after initiating CG-SDT. In some scenarios or implementations, when or while monitoring a PDCCH using the CS-RNTI, the UE receives a DCI and a CRC scrambled with the CS-RNTI on a PDCCH. The UE verifies whether the CRC is valid using the CS-RNTI. In some implementations, if the UE verifies that the CRC is valid and the DCI includes a UL grant, the UE transmits a UL transmission to the RAN using the UL grant. In some implementations, the UL transmission is a new transmission. In other implementations, the UL transmission is a retransmission. In some implementations, if the UE verifies that the CRC is valid and the DCI includes a DL assignment, the UE receives a DL transmission from the RAN using the DL assignment.

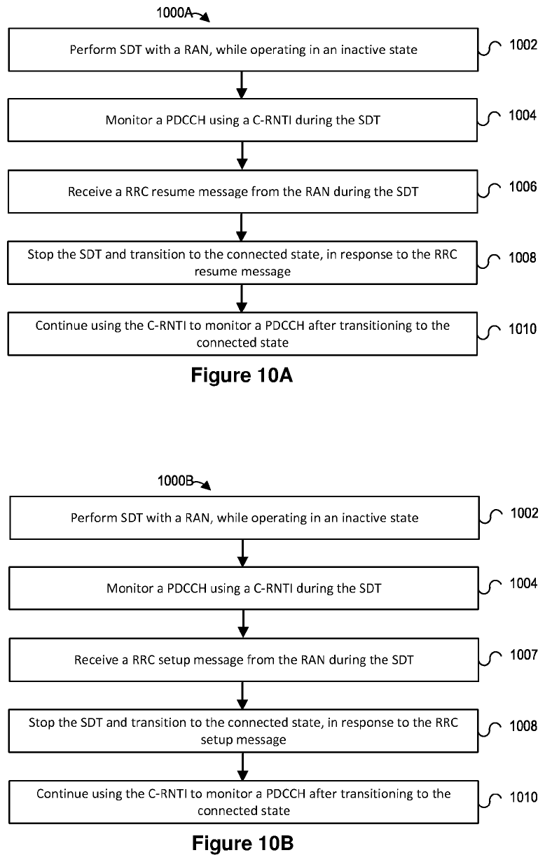

FIG. 10A illustrates a method 1000A, implemented by a UE (e.g., the UE 102), for performing small data communication with a RAN (e.g., the RAN 105 or base station 104, 106).

The method 1000A begins at block 1002, where the UE performs SDT with the RAN, while operating in an inactive state (e.g., events 404, 418, 420, 492, 592, 593 of FIGS. 4-5B). At block 1004, the UE uses a C-RNTI to monitor a PDCCH during the SDT. At block 1006, the UE receives, from the RAN, an RRC resume message during the SDT (e.g., e.g., event 546 of FIGS. 5A-5B). At block 1008, the UE stops the SDT and transitions to a connected state in response to the RRC resume message (e.g., event 548 of FIGS. 5A-5B). At block 1010, the UE continues using the C-RNTI to monitor a PDCCH after transitioning to the connected state. In other words, the UE in the connected state performs data communication with the RAN using the C-RNTI (e.g., events 550, 518 of FIGS. 5A-5B).

In some implementations, the UE starts an SDT session timer for the SDT in response to or after initiating the SDT. The UE stops the SDT session timer in response to or after receiving the RRC resume message.

In some implementations, the UE in the connected state transmits an RRC resume complete message to the RAN in response to the RRC resume message. In some implementations, the SDT is CG-SDT or RA-SDT. In some implementations, the UE operates in the connected state and receives the C-RNTI in a first RRC message (e.g., an RRC reconfiguration message or an RRC resume message) from the RAN before performing the SDT. In some implementations, the UE transmits a first RRC response message (e.g., an RRC reconfiguration complete message or an RRC resume complete message) to the RAN in response to the first RRC message. In other implementations, the UE performs a random access procedure with the RAN to initiate the SDT (i.e., the RA-SDT) and receives the C-RNTI in a random access response in the random access procedure.

For CG-SDT, the UE in the inactive state monitors a PDCCH using the C-RNTI and a CS-RNTI during the CG-SDT. In some implementations, the UE receives a second RRC message including the CS-RNTI from the RAN before performing the SDT. In some implementations, the second RRC message is an RRC reconfiguration message, and the UE in the connected state transmits an RRC reconfiguration complete message to the RAN in response to the RRC reconfiguration message. In other implementations, the second RRC message is an RRC resume message, and the UE transmits an RRC resume complete message to the RAN in response to the RRC resume message. In yet other implementations, the second RRC message is an RRC release message.

In some implementations, when or while monitoring a PDCCH using the C-RNTI, the UE receives a DCI and a CRC scrambled with the C-RNTI on a PDCCH. The UE verifies whether the CRC is correct using the C-RNTI. In some implementations, if the UE verifies that the CRC is correct and the DCI includes a UL grant, the UE transmits a UL transmission to the RAN using the UL grant. In some implementations, the UL transmission is a new transmission. In other implementations, the UL transmission is a retransmission. In some implementations, if the UE verifies that the CRC is correct and the DCI includes a DL assignment, the UE receives a DL transmission from the RAN using the DL assignment.

In some implementations, when or while monitoring a PDCCH using the CS-RNTI during the CG-SDT, the UE in the inactive state receives a DCI and a CRC scrambled with the CS-RNTI on a PDCCH. The UE verifies whether the CRC is correct, using the CS-RNTI. In some implementations, if the UE verifies that the CRC is correct and the DCI includes a UL grant, the UE transmits a UL transmission to the RAN using the UL grant. In some implementations, the UL transmission is a new transmission. In other implementations, the UL transmission is a retransmission.

FIG. 10B is a flow diagram of an example method 1000B similar to the method 1000A, except that method 1000B includes block 1007 instead of block 1006. At block 1007, the UE receives an RRC setup message from the RAN during the SDT.

In some implementations, the UE starts an SDT session timer for the SDT in response to or after initiating the SDT. The UE stops the SDT session timer in response to or after receiving the RRC setup message.

In some implementations, the UE in the connected state transmits an RRC setup complete message to the RAN in response to the RRC setup message. In some implementations, the UE includes a Service Request message in the RRC setup complete message. The UE in the connected state then performs a security mode procedure and an RRC reconfiguration procedure with the RAN to activate security protection and set up an SRB2 and/or a DRB with the RAN, respectively. The UE and RAN generate new security keys as a result of the security mode procedure. Then, the UE in the connected state communicates data with the RAN via an SRB1, the SRB2, or the DRB.

In some implementations, the new security keys include encryption key(s) and integrity key(s). In one implementation, the encryption key(s) include an encryption key for RRC and/or an encryption key for user plane data, and the integrity key(s) include an integrity key for RRC. The UE uses the integrity key(s) to perform an integrity protection operation to data that the UE transmits to the RAN and to perform an integrity check on data that the UE receives from the RAN. The UE uses the encryption key(s) to encrypt data that the UE transmits to the RAN and to decrypt data that the UE receives from the RAN.

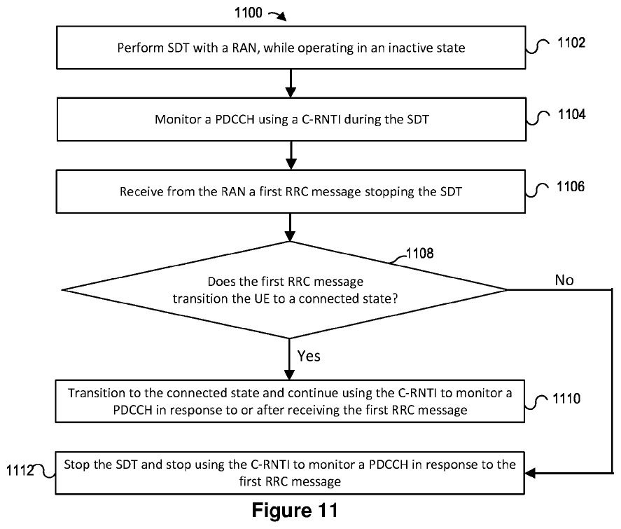

FIG. 11 illustrates a method 1100, implemented by a UE (e.g., the UE 102), for performing small data communication with a RAN (e.g., the RAN 105 or base station 104, 106).

The method 1100 begins at block 1102, where the UE performs SDT with the RAN while operating in an inactive state (e.g., events 404, 418, 420, 492, 592, 593 of FIGS. 4-5B). At block 1104, the UE monitors a PDCCH using a C-RNTI during the SDT. At block 1106, the UE receives from the RAN a first RRC message during the SDT (e.g., e.g., events 434, 546 of FIGS. 4-5B). At block 1108, the UE determines whether the first RRC message causes the UE to transition to a connected state. If the UE determines that the first RRC message causes the UE to transition to the connected state, the flow proceeds to block 1110. At block 1110, the UE transitions to the connected and continues using the C-RNTI to monitor a PDCCH. In other words, the UE in the connected state performs data communication with the RAN using the C-RNTI (e.g., events 550, 518 of FIGS. 5A-5B), in response to the first RRC message or after receiving the first RRC message.

Otherwise, if the UE determines that the first RRC message does not cause the UE to transition to the connected state, the flow proceeds to block 1112. At block 1112, the UE stops the SDT and stops using the C-RNTI to monitor a PDCCH in response to the first RRC message.

In cases where the first RRC message transitions the UE to the connected state, the UE stops the SDT, transitions to the connected state, and transmits a first RRC response message to the RAN node in response to the first RRC message. In some implementations, the first RRC message and the first RRC response message are an RRC resume message and an RRC resume complete message, respectively. In other implementations, the first RRC message and the first RRC response message are an RRC setup message and an RRC setup complete message, respectively. In cases where the first RRC message does not cause the UE to transition to the connected state, the first RRC message is an RRC release message (e.g., event 434 of FIG. 4) or an RRC reject message. The UE stops the SDT and remains in the inactive state in response to or after receiving the first RRC message.

In some implementations, the UE starts an SDT session timer for the SDT in response to performing the SDT (e.g., initiating the SDT or transmitting a UL RRC message for initiating the SDT, similar to event 404). The UE stops the SDT session timer in response to or after receiving the first RRC message.

In some implementations, the SDT is CG-SDT or RA-SDT. In some implementations, the UE receives the C-RNTI in a second RRC message (e.g., an RRC reconfiguration message or an RRC resume message) from the RAN before initiating the SDT. In further implementations, the UE transmits a second RRC response message (e.g., an RRC reconfiguration complete message or an RRC resume complete message) to the RAN in response to the second RRC message. In other implementations, the UE performs a random access procedure to initiate the SDT (i.e., the RA-SDT) and receives the C-RNTI in a random access response of the random access procedure.

For CG-SDT, the UE monitors a PDCCH using the C-RNTI and a CS-RNTI during the CG-SDT. In some implementations, the UE receives a third RRC message, including the CS-RNTI, from the RAN before initiating the CG-SDT. In some implementations, the third RRC message is an RRC reconfiguration message and the UE transmits an RRC reconfiguration complete message to the RAN in response. In other implementations, the third RRC message is an RRC resume message and the UE transmits an RRC resume complete message to the RAN in response. In yet other implementations, the third RRC message is an RRC release message.

In some scenarios or implementations, when or while monitoring a PDCCH using the C-RNTI, the UE receives a DCI and a CRC scrambled with the C-RNTI on a PDCCH. The UE verifies whether the CRC is correct using the C-RNTI. In some implementations, if the UE verifies that the CRC is correct and the DCI includes a UL grant, the UE transmits a UL transmission to the RAN using the UL grant. In some implementations, the UL transmission is a new transmission. In other implementations, the UL transmission is a retransmission. In some implementations, if the UE verifies that the CRC is correct and the DCI includes a DL assignment, the UE receives a DL transmission from the RAN using the DL assignment.

In some implementations, when or while monitoring a PDCCH using the CS-RNTI during the CG-SDT, the UE receives a DCI and a CRC scrambled with the CS-RNTI on a PDCCH. The UE verifies whether the CRC is correct using the CS-RNTI. In some implementations, if the UE verifies that the CRC is correct and the DCI includes a UL grant, the UE transmits a UL transmission to the RAN using the UL grant. In some implementations, the UL transmission is a new transmission. In other implementations, the UL transmission is a retransmission.

Example and implementations described for FIGS. 10A and 10B can apply to FIG. 11.

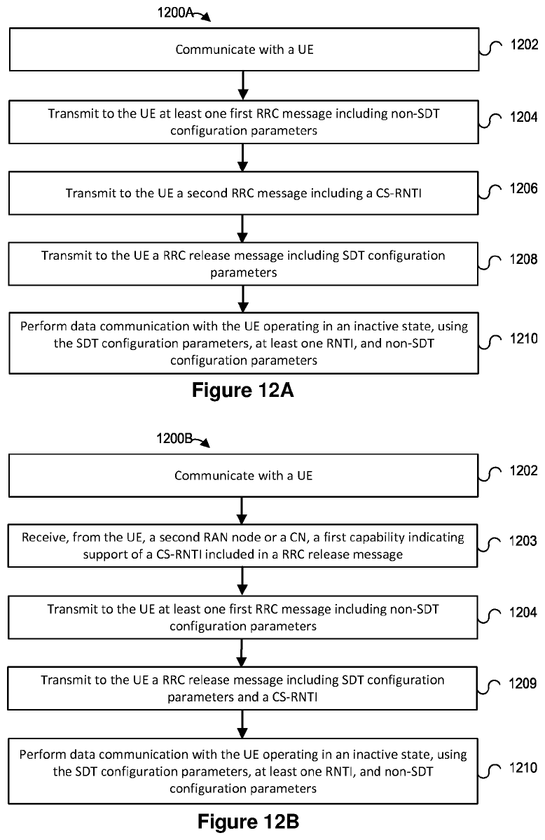

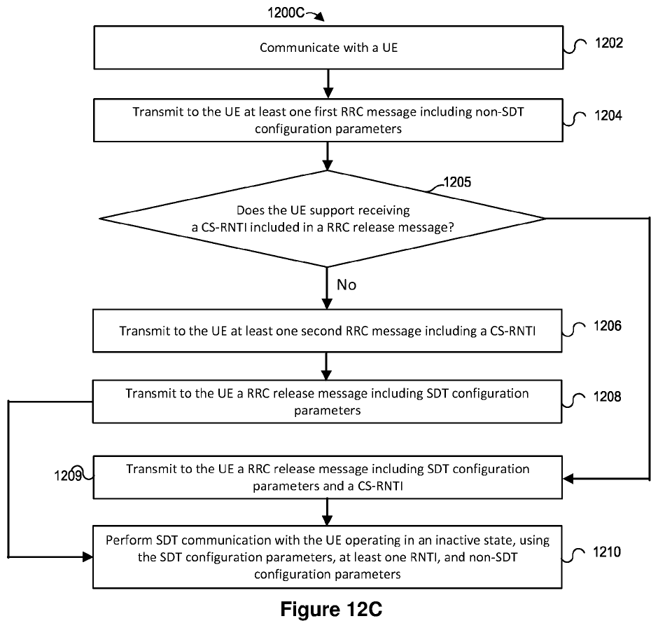

FIG. 12A illustrates a method 1200A, implemented by a RAN node (e.g., the DU 174 or base station 104, 106), for performing data communication with a UE (e.g., the UE 102) via a CU (e.g., the CU 172 or the CU-CP 172A).

The method 1200A begins at block 1202, where the RAN node communicates with the UE (e.g., events 304, 306, 318, 310, 312, 316, 314, 318, 390, 320, 321, 322, 404, 406, 408, 410, 415, 416, 418, 494, 420, 421, 422, 503, 592, 546, 550, 518, 588, 590 of FIGS. 3-5B). At block 1204, the RAN node transmits, to the UE, at least one first RRC message including non-SDT configuration parameters (e.g., events 312, 390, 340, 440, 546, 590). At block 1206, the RAN node transmits, to the UE, a second RRC message including a CS-RNTI (e.g., events 312, 390, 340, 440, 546, 590 of FIGS. 3-5B). At block 1208, the RAN node transmits, to the UE, an RRC release message including SDT configuration parameters (e.g., events 334, 434, 494, 594, 595 of FIGS. 3-5B). At block 1210, the RAN node performs data communication with the UE operating in an inactive state using a C-RNTI of the UE, the SDT configuration parameters, the CS-RNTI, and the non-SDT configuration parameters (e.g., events 404, 418, 492, 420, 440, 434, 592, 546 of FIGS. 3-5B).

In some implementation, SDT configuration parameters include configuration parameters for SDT (e.g., CG-SDT and/or RA-SDT) as described above. In some implementations, the non-SDT configuration parameters include configuration parameters for non-SDT as described above. In some implementations, the at least one first RRC message includes the second RRC message, RRC reconfiguration message(s), and/or RRC resume message(s). In some implementations, the second RRC message is an RRC reconfiguration message or an RRC resume message. In some implementations, the second RRC message does not include a CG configuration. In some implementations, the RRC release message does not include the CS-RNTI.

FIG. 12B is a flow diagram of an example method 1200B similar to the method 1200A, except that method 1200B includes blocks 1203 and 1209 instead of blocks 1206 and 1208. At block 1203, the RAN node receives, from the UE, a second RAN node, or a CN, a first capability indicating support of receiving a CS-RNTI included in an RRC release message. At block 1209, the RAN node transmits, to the UE, an RRC release message including SDT configuration parameters and a CS-RNTI (e.g., events 334, 434, 494, 594, 595 of FIGS. 3-5B).

In some implementations, the RAN decides to include the CS-RNTI in the RRC release message in accordance with the first capability. If the UE does not transmit the first capability to the RAN, the RAN transmits a second RRC message including the CS-RNTI to the UE, as described for block 1206 of FIG. 12A.

FIG. 12C is a flow diagram of an example method 1200C similar to the methods 1200A and 1200B, except that method 1200C includes block 1205 instead of block 1203. At block 1205, the RAN node determines whether the UE supports receiving a CS-RNTI included in an RRC release message. If the RAN node determines that the UE supports receiving a CS-RNTI included in an RRC release message, the flow proceeds to blocks 1206 and 1208. Otherwise, if the RAN node determines that the UE does not support receiving a CS-RNTI included in an RRC release message, the flow proceeds to block 1209. The flow proceeds to block 1210 from block 1209 as well as block 1208.

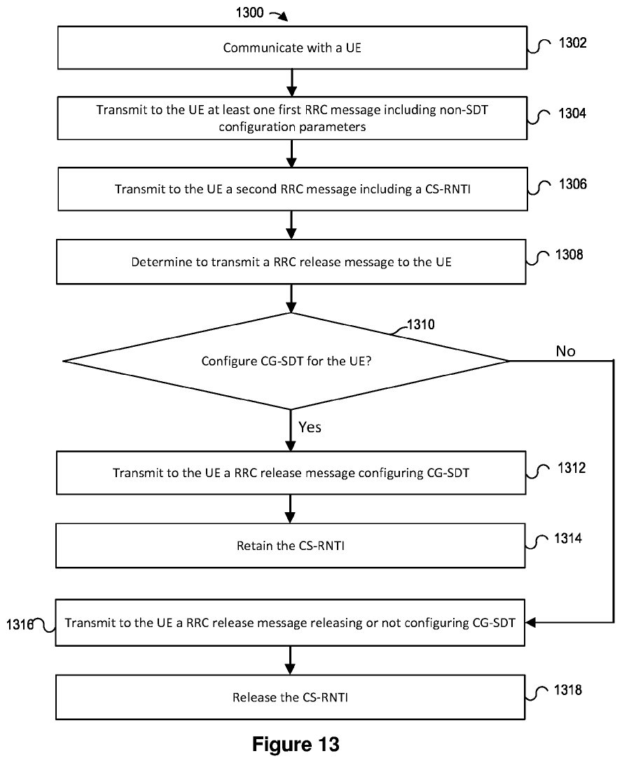

FIG. 13 illustrates a method 1300, implemented by a RAN node (e.g., the DU 174 or base station 104, 106), for performing data communication with a UE (e.g., the UE 102).

The method 1300 begins at block 1302, where the RAN node communicates with the UE (e.g., events 304, 306, 318, 310, 312, 316, 314, 318, 390, 320, 321, 322, 404, 406, 408, 410, 415, 416, 418, 494, 420, 421, 422, 503, 592, 546, 550, 518, 588, 590 of FIGS. 3-5B). At block 1304, the RAN node transmits, to the UE, at least one first RRC message including non-SDT configuration parameters (e.g., events 312, 390, 340, 440, 546, 590 of FIGS. 3-5B). At block 1306, the RAN node transmits, to the UE, a second RRC message including a CS-RNTI (e.g., events 312, 390, 340, 440, 546, 590 of FIGS. 3-5B). At block 1308, the RAN node determines to transmit, to the UE, an RRC release. At block 1310, the RAN node determines whether to configure CG-SDT for the UE. If the RAN node determines to configure CG-SDT for the UE, the flow proceeds to block 1312. At block 1312, the RAN node transmits, to the UE, an RRC release message configuring CG-SDT (e.g., events 334, 434, 494, 594, 595 of FIGS. 3-5B). In some implementations, the RAN node includes a CG-SDT configuration in the RRC release message to configure CG-SDT. In other implementations, the RAN node does not include a CG-SDT configuration in the RRC release message because the RAN node transmitted to the UE another RRC release message including a CG-SDT configuration before. In such cases, the RAN node refrains from including a CG-SDT configuration in the RRC release message to indicate to reuse the CG-SDT configuration in the RRC release message. At block 1314, the RAN node retains the CS-RNTI. In some implementations, the RAN node later performs data communication with the UE operating in an inactive state, using a C-RNTI of the UE, the CG-SDT configuration parameter, the CS-RNTI, and the non-SDT configuration parameters (e.g., events 404, 418, 492, 420, 440, 434, 592, 546 of FIGS. 3-5B).

Otherwise, if the RAN node determines to release or not to configure CG-SDT for the UE, the flow proceeds to block 1316. At block 1316, the RAN node transmits, to the UE, an RRC release message releasing or not configuring CG-SDT. At block 1318, the RAN node releases the CS-RNTI.

In some implementations, the at least one first RRC message includes the second RRC message, RRC reconfiguration(s), and/or RRC resume message(s). In some implementations, the second RRC message is an RRC reconfiguration message. In other implementations, the second RRC message is an RRC resume message. In some implementations, the CG-SDT configuration includes a configured grant (CG) configuration (e.g., ConfiguredGrantConfig 1E). The CG configuration includes configuration parameters to configure a configured grant periodically occurring in the time domain (e.g., CG occasions such as slots). When the UE performs CG-SDT, the UE transmits UL MAC PDU(s) in slot(s) to the RAN node in accordance with the configured grant.

In cases where the RRC release message configures CG-SDT, the RAN node attempts to receive, from the UE operating in the inactive state, a UL transmission in a CG occasion using the configured grant. If the RAN node receives a UL transmission in a CG occasion using the configured grant, the RAN node obtains a UL MAC PDU from the UL transmission and retrieves UL PDCP PDU(s) from the UL MAC PDU. In some implementations, the RAN node retrieves UL RLC PDU(s) from the UL MAC PDU and retrieves the UL PDCP PDU(s) from the UL RLC PDU(s). In other implementations, the RAN node retrieves the UL PDCP PDU(s) from the UL MAC PDU(s). In cases where the RAN node is a DU, the DU transmits the UL PDCP PDU(s) to a CU. The CU retrieves UL data from the UL PDCP PDU(s). In some implementations, the UL MAC PDU includes logical channel ID(s) for the UL RLC PDU(s) or UL PDCP PDU(s), respectively. If a logical channel ID identifies or indicates a common control channel (CCCH) or a dedicated control channel (DCCH), the DU transmits the respective UL PDCP PDU to a CP of the CU. If a logical channel ID identifies or indicates a dedicated traffic channel (DCCH), the DU transmits the respective UL PDCP PDU to a UP of the CU.

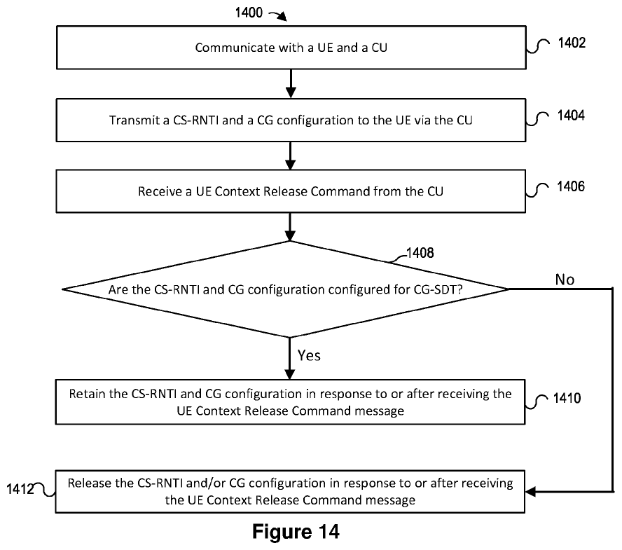

FIG. 14 illustrates a method 1400, implemented by a DU (e.g., the DU 174), for performing data communication with a UE (e.g., the UE 102) via a CU (e.g., the CU 172).

The method 1400 begins at block 1402, where the DU communicates with the UE and CU (e.g., events 304, 306, 318, 310, 312, 316, 314, 318, 390, 320, 321, 322, 404, 406, 408, 410, 415, 416, 418, 494, 420, 421, 422, 503, 592, 546, 550, 518, 588, 590 of FIGS. 3-5B). At block 1404, the DU transmits a CS-RNTI and a configured grant (CG) configuration to the UE (e.g., events 312, 390, 340, 334, 440, 434, 494, 546, 590, 594, 595 of FIGS. 3-5B). At block 1406, the DU receives a UE Context Release Command message from the CU (e.g., events 332, 394, 432, 494, 594, 595 of FIGS. 3-5B).

At block 1408, the DU determines whether the CS-RNTI and CG configuration are configured for CG-SDT. If the DU determines that the CS-RNTI and CG configuration are configured for SDT, the flow proceeds to block 1410. At block 1410, the DU retains the CS-RNTI and CG configuration in response to or after receiving the IJE Context Release Command message. Otherwise, if the DU determines that the CS-RNTI and/or CG configuration are configured for non-SDT (i.e., data communication in a connected state), the flow proceeds to block 1412. At block 1412, the DU releases the CS-RNTI and/or CG configuration in response to or after receiving the ULE Context Release Command message. In other words, the DU determines that the CS-RNTI and/or CG configuration are invalid in response to or after receiving the UJE Context Release Command message.

The CG configuration configures a configured grant periodically occurring in the time domain (e.g., CG occasions such as slots). In cases where the DU retains the CS-RNTI and CG configuration, the DU in some implementations attempts to receive, from the UE, UL transmissions on radio resources configured in the CG configuration, when or after transmitting the CS-RNTI and CG configuration to the UE or CU. In cases where the DU releases the CS-RNTI and/or the CG configuration, the DU refrains from receiving or stops attempting to receive, from the UE, UL transmissions on radio resources configured in the CG configuration.

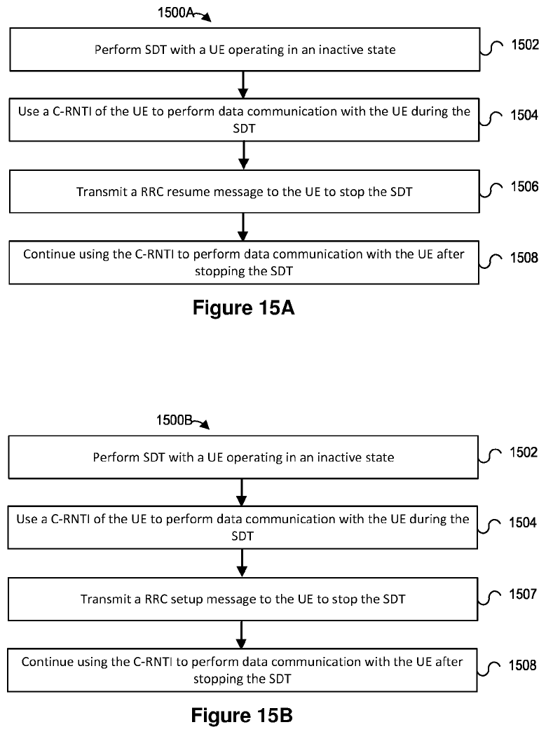

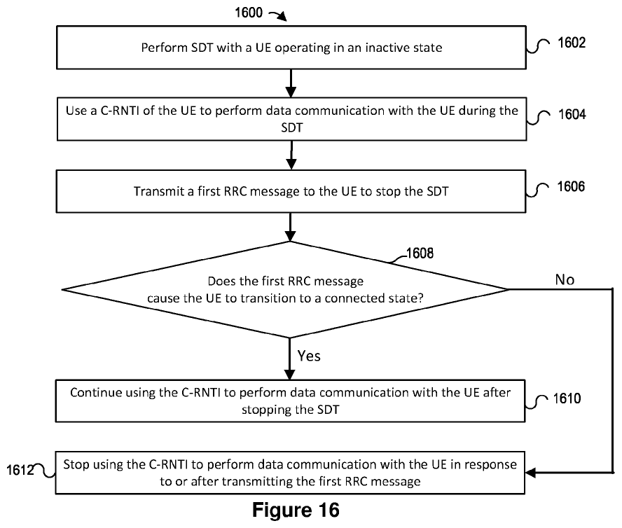

FIG. 15A illustrates a method 1500A, implemented by a RAN node (e.g., the DU 174 or base station 104, 106), for performing data communication with a UE (e.g., the UE 102).

The method 1500A begins at block 1502, where the RAN node performs SDT with the UE operating in an inactive state (e.g., events 404, 418, 420, 492, 592, 593 of FIGS. 4-5B). At block 1504, the RAN node uses a C-RNTI of the UE to perform data communication with the UF during the SDT (eg, events 404, 418, 420, 434, 492, 592, 593 of FIGS. 4-5B). At block 1506, the RAN node transmits an RRC resume message to the UE to stop the SDT (e.g., e.g., event 546 of FIGS. 5A-5B). At block 1508, the RAN node continues using the C-RNTI to perform data communication with the UE after stopping the SDT (e.g., events 550, 518 of FIGS. 5A-5B).

In some implementations, the UE stops the SDT, transitions to a connected state, and transmits an RRC resume complete message to the RAN node in response to the RRC resume message. In some implementations, the RAN node determines that the UE transitions to the connected state in response to receiving the RRC resume complete message. Thus, the RAN node performs data communication with the UE operating in the connected state using the C-RNTI after stopping the SDT. In cases where the RAN node is a DU, the DU receives a CU-to-DU message (e.g., a FIAP message such as a DI. RRC Message Transfer message), including the RRC resume message, from a CU (e.g., CU 172 or CU-CP 172A) and transmits a DU-to-CU message (e.g., a F1AP message such as a DI. RRC Message Transfer message), including the RRC resume complete message, to the CU, as described for events 545 and 552, respectively.

In some implementations, the RAN node starts an SDT session timer for the SDT in response to performing the SDT (e.g., receiving an UL RRC message for initiating the SDT, similar to event 404). The RAN node stops the SDT session timer in response to or after transmitting the RRC resume message or receiving the RRC resume complete message.

In some implementations, the SDT is CG-SDT or RA-SDT. In some implementations, the RAN node transmits a first RRC message (e.g., an RRC reconfiguration message or an RRC resume message), including the first C-RNTI, to the UF before performing the SDT procedure. In further implementations, the UE transmits a first RRC response message (e.g., an RRC reconfiguration complete message or an RRC resume complete message) to the RAN node in response to the first RRC message. In other implementations, the UE performs a random access procedure with the RAN node to initiate the SDT (i.e., the RA-SDT). The RAN node transmits a random access response, including the C-RNTI, to the UE in the random access procedure.

For CG-SDT, the RAN uses the C-RNTI and a CS-RNTI of the UE to perform data communication with the UE. The RAN node transmits a second RRC message, including the CS-RNTI, to the UE before performing the CG-SDT. In some implementations, the second RRC message is an RRC reconfiguration message, and the UF transmits an RRC reconfiguration complete message to the RAN in response. In other implementations, the second RRC message is an RRC resume message, and the UE transmits an RRC resume complete message to the RAN in response. In yet other implementations, the second RRC message is an RRC release message. In some implementations, the second RRC message includes a CG-SDT configuration configuring CG resources for the CG-SDT. Alternatively, the RAN node transmits a third RRC message including the CG-SDT configuration to the UE. In some implementations, the third RRC message is an RRC reconfiguration message, and the UE transmits an RRC reconfiguration complete message to the RAN in response. In other implementations, the third RRC message is an RRC resume message, and the UE transmits an RRC resume complete message to the RAN in response. In yet other implementations, the third RRC message is an RRC release message. In some implementations, the RAN node stops using the CS-RNTI to communicate with the UE in response to or after stopping the SDT. In some implementations, the RAN node refrains from receiving or stops attempting to receive, from the UE, UL transmissions on radio resources configured in the CG configuration in response to or after stopping the SDT. In some implementations, the RAN node releases the CG-SDT configuration in response to or after transmitting the RRC resume message.

When using the C-RNTI to perform data communication with the UE, the RAN node generates DCI(s), generates a CRC for each of the DCI(s), and scrambles the CRC with the C-RNTI. The RAN node transmits the DCI and scrambled CRC on a PDCCH to the UE during the SDT procedure. Each of the DCI(s) includes a DL assignment or a UL grant. If a DCI includes a DL assignment, the RAN node transmits a DL transmission to the UE in accordance with the DCI or DL assignment. If a DCI includes a UL assignment, the RAN node receives a UL transmission from the UE in accordance with the DCI or UL grant.

When using the CS-RNTI to perform data communication with the UE, the RAN node generates DCI(s), generates a CRC for each of the DCI(s), and scrambles each CRC with the CS-RNTI. The RAN node transmits the DCI(s) and scrambled CRC(s) on a PDCCH to the UE during the SDT procedure. Each of the DCI(s) includes a UL grant. The RAN node receives a UL transmission from the UE in accordance with the DCI or UL grant.

FIG. 15B is a flow diagram of an example method 1500B similar to the method 1500A, except that method 1500B includes block 1507 instead of block 1506. At block 1507, the RAN node transmits an RRC setup message to the UE to stop the SDT.

In some implementations, the UE transitions to a connected state and transmits an RRC setup complete message to the RAN node in response to the RRC setup message. In some implementations, the RAN node determines that the UE transitions to the connected state in response to receiving the RRC setup complete message. Thus, the RAN node performs data communication with the UE operating in the connected state using the C-RNTI after stopping the SDT. In cases where the RAN node is a DU, the DU receives a CU-to-DU message (e.g., a F1AP message such as a DL RRC Message Transfer message), including the RRC setup message, from a CU (e.g., CU 172 or CU-CP 172A) and transmits a DU-to-CU message (e.g., a F1AP message such as a (I. RRC Message Transfer message), including the RRC setup complete message, to the CU, similar to events 545 and 552, respectively.

In some implementations, the RAN node starts an SDT session timer for the SDT in response to performing the SDT (e.g., receiving a UL RRC message for initiating the SDT, similar to event 404). The RAN node stops the SDT session timer in response to or after transmitting the RRC setup message or receiving the RRC setup complete message.

In some implementations, the RRC setup complete message includes a Service Request message, and the RAN node sends the Service Request message to a CN (e.g., CN 110 or AMF 164). The RAN then performs a security mode procedure and an RRC reconfiguration procedure with the UE operating in the connected state to activate security protection and set up an SRB2 and/or a DRB for the UE, respectively. The UE and RAN generate new security keys as a result of the security mode procedure. After that, the RAN communicates data via a SRB1, the SRB2 or the DRB with the UE operating in the connected state.

In some implementations, the new security keys include encryption key(s) and integrity key(s). In one implementation, the encryption key(s) include an encryption key for RRC and/or an encryption key for user plane data, and the integrity key(s) include an integrity key for RRC. The RAN node uses the integrity key to perform integrity protection procedures to data that the RAN node transmits to the UE and to perform integrity checks on data that the RAN node receives from the UE. The RAN node uses the encryption key to encrypt data that the RAN node transmits to the UE and to decrypt data that the RAN node receives from the UE.

FIG. 16 illustrates a method 1600, implemented by a RAN (e.g., the RAN 105 or a RAN node such as a base station 104, 106) for performing small data communication with a UE (e.g., the UE 102).

The method 1600 begins at block 1602, where the RAN performs SDT with the UE operating in an inactive state (e.g., events 404, 418, 420 492, 592, 593 of FIGS. 4-5B). At block 1604, the RAN node uses a C-RNTI of the UE to perform data communication with the UE during the SDT (e.g., events 404, 418, 420, 434, 492, 592, 593 of FIGS. 4-5B). At block 1606, the RAN node transmits a first RRC message to the UE to stop the SDT (e.g., e.g., events 434, 546 of FIGS. 4-5B). At block 1608, the RAN node determines whether the first RRC message causes the UE to transition to a connected state. If the RAN node determines that the first RRC message causes the UE to transition to the connected state, the flow proceeds to block 1610. At block 1610, the RAN node continues using the C-RNTI to perform data communication with the UE after stopping the SDT. In other words, the RAN node performs data communication with the UE operating in the connected state, using the C-RNTI (e.g., events 550, 518 of FIGS. 5A-5B).

Otherwise, if the RAN node determines that the first RRC message does not cause the UE to transition to the connected state, the flow proceeds to block 1612. At block 1612, the RAN node stops using the C-RNTI to perform data communication with the UE after transmitting the first RRC message.

In cases where the first RRC message causes the UE to transition to the connected state, the UE stops the SDT, transitions to the connected state, and transmits a first RRC response message to the RAN node in response to the first RRC message. In some implementations, the RAN node determines that the UE transitions to the connected state in response to receiving the first RRC response message. In some implementations, the first RRC message and the first RRC response message are an RRC resume message and an RRC resume complete message, respectively. In other implementations, the first RRC message and the first RRC response message are an RRC setup message and an RRC setup complete message, respectively. In cases where the first RRC message does not cause the UE to transition to the connected state, the first RRC message is an RRC release message (e.g., event 434 of FIG. 4) or an RRC reject message. The UE stops the SDT and remains in the inactive state in response to or after receiving the first RRC message. In such cases, the RAN node determines that the UE stops the SDT in response to or after transmitting the first RRC message.

In some implementations, the RAN node starts an SDT session timer for the SDT in response to performing the SDT (e.g., receiving an UL RRC message for initiating the SDT, similar to event 404). The RAN node stops the SDT session timer in response to or after transmitting the first RRC message or receiving the first RRC response message.

In some implementations, the SDT is CG-SDT or RA-SDT. In some implementations, the RAN node transmits a second RRC message (e.g., an RRC reconfiguration message or an RRC resume message) including the C-RNTI to the UE before the SDT. In further implementations, the UF transmits a second RRC response message (e.g., an RRC reconfiguration complete message or an RRC resume complete message) to the RAN in response to the second RRC message. In other implementations, the UE performs a random access procedure to initiate the SDT (i.e., the RA-SDT). The RAN node transmits a random access response including the C-RNTI to the UE in the random access procedure.

For CG-SDT, the RAN uses the C-RNTI and a CS-RNTI of the UE to perform data communication with the UE. The RAN node transmits a third RRC message including the CS-RNTI to the UE before the CG-SDT procedure. In some implementations, the third RRC message is an RRC reconfiguration message, and the UE transmits an RRC reconfiguration complete message to the RAN in response. In other implementations, the third RRC message is an RRC resume message, and the UE transmits an RRC resume complete message to the RAN in response. In yet other implementations, the third RRC message is an RRC release message. In some implementations, the third RRC message includes CG-SDT configuration(s) configuring CG resources for the CG-SDT. Alternatively, the RAN node transmits fourth RRC message including the CG-SDT configuration(s) to the UE. In some implementations, the fourth RRC message is an RRC reconfiguration message, and the UE transmits an RRC reconfiguration complete message to the RAN in response. In other implementations, the fourth RRC message is an RRC resume message, and the UE transmits an RRC resume complete message to the RAN in response. In yet other implementations, the fourth RRC message is an RRC release message. In some implementations, the RAN node stops using the CS-RNTI in response to or after stopping the SDT. In some implementations, the RAN node stops attempting to receive UL transmission(s) on the CG resources in response to or after stopping the SDT. In some implementations, the RAN node releases the CG-SDT configuration(s) in response to or after transmitting the first RRC message.

Example and implementations described for FIGS. 15A and 15B can apply to FIG. 16.

The following description may be applied to the description above.

Generally speaking, description for one of the above figures can apply to another of the above figures. An event or block described above can be optional or omitted. For example, an event or block with dashed lines in the figures can be optional or omitted. In some cases, an event or block with solid lines in the figures can still be optional or omitted if the event or block is not necessary. In some implementations, a “message” (as the term is used above) can be replaced by “information element (IE),” and vice versa. In some implementations, an “IE” (as the term is used above) can be replaced by “field,” and vice versa. In some implementations, a “configuration” (as the term is used above) can be replaced by “configurations” or “configuration parameters,” and vice versa. In some implementations, “small data transmission” (as the term is used above) can be replaced by “early data transmission” (and “SDT” can be replaced by “EDT”), and vice versa. In some implementations, “small data transmission” (as the term is used above) can be replaced by “small data communication,” and vice versa. In some implementations, “stop” (as the term is used above) can be replaced by “suspend.”

A user device in which the techniques of this disclosure can be implemented (e.g., the UE 102) can be any suitable device capable of wireless communications such as a smartphone, a tablet computer, a laptop computer, a mobile gaming console, a point-of-sale (POS) terminal, a health monitoring device, a drone, a camera, a media-streaming dongle or another personal media device, a wearable device such as a smartwatch, a wireless hotspot, a femtocell, or a broadband router. Further, the user device in some cases may be embedded in an electronic system such as the head unit of a vehicle or an advanced driver assistance system (ADAS). Still further, the user device can operate as an internet-of-things (IoT) device or a mobile-internet device (MID). Depending on the type, the user device can include one or more general-purpose processors, a computer-readable memory, a user interface, one or more network interfaces, one or more sensors, etc.

Certain embodiments are described in this disclosure as including logic or a number of components or modules. Modules may can be software modules (e.g., code, or machine-readable instructions stored on non-transitory machine-readable medium) or hardware modules. A hardware module is a tangible unit capable of performing certain operations and may be configured or arranged in a certain manner. A hardware module can comprise dedicated circuitry or logic that is permanently configured (e.g., as a special-purpose processor, such as a field programmable gate array (FPGA) or an application-specific integrated circuit (ASIC), a digital signal processor (DSP), etc.) to perform certain operations. A hardware module may also comprise programmable logic or circuitry (e.g., as encompassed within a general-purpose processor or other programmable processor) that is temporarily configured by software to perform certain operations. The decision to implement a hardware module in dedicated and permanently configured circuitry, or in temporarily configured circuitry (e.g., configured by software) may be driven by cost and time considerations.

When implemented in software, the techniques can be provided as part of the operating system, a library used by multiple applications, a particular software application, etc. The software can be executed by one or more general-purpose processors or one or more special-purpose processors.

1. A method for wireless communication implemented in a UE, the method comprising:
monitoring a physical downlink control channel (PDCCH) using a radio network temporary identifier (RNTI), during a small data transmission (SDT) procedure and when the UE operates in an inactive state;
transitioning from the inactive state to a connected state in response to a command from a radio access network (RAN); and
monitoring the PDCCH using the RNTI after the transitioning, when the UE operates in the connected state.

2. The method of claim 1, wherein:
the RNTI is a cell RNTI (C-RNTI).

3. The method of claim 1, wherein:
the command from the RAN includes a radio resource control (RRC) resume message.

4. The method of claim 1, wherein:
the command from the RAN includes an RRC setup message.

5. The method of claim 1, wherein:
the monitoring of the PDCCH using the RNTI after the transitioning is in response to the command.

6. The method of claim 1, wherein:
the SDT procedure is a configured grant SDT (CG-SDT) procedure.

7. A user equipment (UE) comprising:
a transceiver; and
processing hardware configured to:
monitor a physical downlink control channel (PDCCH) using a radio network temporary identifier (RNTI), during a small data transmission (SDT) procedure and when the UE operates in an inactive state,
transition from the inactive state to a connected state in response to a command from a radio access network (RAN), and
monitor the PDCCH using the RNTI after the transition, when the UE operates in the connected state.

8. A method for wireless communication implemented in a radio access network (RAN) node, the method comprising:
performing a small data transmission (SDT) procedure with a user equipment (UE), when the UE operates in an inactive state, using a radio network temporary identifier (RNTI);
transmitting, to the UE, a command to transition from the inactive state to a connected state; and
communicating with the UE using the RNTI, when the UE operates in the connected state.

9. The method of claim 8, wherein the RNTI is a cell RNTI (C-RNTI).

10. The method of claim 8, wherein:
the command from the RAN node includes a radio resource control (RRC) resume message.

11. The method of claim 8, wherein:
the command from the RAN includes an RRC setup message.

12. The method of claim 8, wherein:
the communicating with the UE using the RNTI is in response to the command to transition to the connected state.

13. The method of claim 8, wherein:
the SDT procedure is a configured grant SDT (CG-SDT) procedure.

14. The method of claim 8, further comprising:
transmitting, to the UE prior to performing the SDT procedure, an RRC message including the RNTI.

15. (canceled)

16. The UE of claim 7, wherein:
the RNTI is a cell RNTI (C-RNTI).

17. The UE of claim 16, wherein:
the command from the RAN includes a radio resource control (RRC) resume message.

18. The UE of claim 7, wherein:
the command from the RAN includes a radio resource control (RRC) resume message.

19. The UE of claim 7, wherein:
the command from the RAN includes an RRC setup message.

20. The UE of claim 7, wherein:
to monitor of the PDCCH using the RNTI after the transition is in response to the command.

21. The UE of claim 7, wherein:
the SDT procedure is a configured grant SDT (CG-SDT) procedure.
